(19) United States
(12) Patent Application Publication
(10) Pub. No.: US 2021/0396006 A1
(43) Pub. Date: Dec. 23, 2021

(54) MODULAR BUILDING SYSTEM

(71) Applicant: Innovative Building Technologies, LLC, Seattle, WA (US)

(72) Inventors: Arlan COLLINS, Seattle, WA (US); Mark WOERMAN, Seattle, WA (US); Mark D'AMATO, Seattle, WA (US)

(73) Assignee: Innovative Building Technologies, LLC, Seattle, WA (US)

(21) Appl. No.: 17/293,197

(22) PCT Filed: Jun. 21, 2019
(86) PCT No.: PCT/US2019/038593

§ 371 Date: May 12, 2021

Related U.S. Application Data
(60) Provisional application No. 62/767,311, filed on Nov. 14, 2018.

(51) Int. Cl. E04B 2/58; E04B 5/10; E04B 7/02; E04B 1/62; E04B 1/76; E04B 1/82; E04F 13/14; E04F 15/20; E04F 13/08; B32B 5/18; B32B 13/04; B32B 13/06; B32B 7/08; B32B 5/02; B32B 19/06; B32B 3/06

(52) U.S. Cl. CPC E04B 2/58; B32B 2307/7246; E04B 7/022; E04B 1/625; E04B 1/7654; E04B 1/82; E04F 13/14; E04F 15/203; E04F 13/0803; B32B 5/18; B32B 13/045; B32B 13/06; B32B 7/08; B32B 5/02; B32B 19/06; B32B 3/06; B32B 2419/04; B32B 2307/304; B32B 2262/101; B32B 2419/06; B32B 2307/712; E04B 5/10

(57) ABSTRACT

A manufactured building system is described. The building system can include modular components such as floor panels, roof panels, window walls, demising walls, utility walls, end walls, and/or corbel beams.

### RELATED APPLICATIONS

This application claims the benefit of U.S. application Ser. No. 62/767,311, entitled “Modular Building System,” and filed on Nov. 14, 2018, which is incorporated herein by reference in its entirety.

### BACKGROUND

Conventional construction is conducted in the field at the building job site. People in various trades (e.g., carpenters, electricians, and plumbers) measure, cut, and install material as though each unit were one-of-a-kind. Furthermore, activities performed by the trades are arranged in a linear sequence. The result is a time-consuming process that increases the risk of waste, installation imperfections, and cost overruns.

Traditional building construction continues to be more and more expensive and more and more complex. Changing codes, changing environments, and new technology have all made the construction of a building more complex than it was 10 or more years ago. In addition, trade labor availability is being reduced significantly. As more and more craftsmen retire, fewer and fewer younger workers may be choosing the construction industry as a career, leaving the construction industry largely lacking in skilled and able men and women to do the growing amount of construction work.

### SUMMARY

Some implementations can include a modular building system including floor panels, roof panels, window walls, demising walls, utility walls, and end walls.

In some implementations, a modular building system can include a floor panel, including a first cement board layer, a hydronic foam layer disposed below the first cement board layer, and hydronic piping disposed within the hydronic foam layer. The floor panel can also include a second cement board layer disposed below the hydronic foam layer, one or more joists coupled to a bottom surface of the second cement board layer, and one or more gypsum board layers disposed below the one or more joists, wherein the one or more joists are coupled to a top surface of the one or more gypsum board layers. The floor panel can further include one or more layers of insulation disposed in a space defined by the second cement board layer, the one or more joists, and the one or more gypsum board layers.

In some implementations, the floor panel can also include a first sheet metal member disposed between the second cement board layer and a top of the one or more joists, and a second sheet metal member disposed between a bottom of the one or more joists and a top surface of the one or more gypsum board layers. In some implementations, the first cement board layer and the second cement board layer can be attached to the first sheet metal member via one or more fasteners.

In some implementations, the one or more gypsum board layers can include two fiberglass sheathed gypsum board layers.

Some implementations can include a roof panel, having a roofing material layer, a protection board layer disposed beneath the roofing material layer, and a rigid insulation layer disposed beneath the protection board layer. The roof panel can also include a vapor retarder disposed beneath the rigid insulation layer, a first cement board layer, a hydronic foam layer disposed below the first cement board layer, and hydronic piping disposed within the hydronic foam layer. The roof panel can further include a second cement board layer disposed below the hydronic foam layer, one or more joists coupled to a bottom surface of the second cement board layer, one or more gypsum board layers disposed below the one or more joists, wherein the one or more joists are coupled to a top surface of the one or more gypsum board layers, and one or more layers of insulation disposed in a space defined by the second cement board layer, the one or more joists, and the one or more gypsum board layers.

The roof panel can also include a first sheet metal member disposed between the second cement board layer and a top of the one or more joists, and a second sheet metal member disposed between a bottom of the one or more joists and a top surface of the one or more gypsum board layers. In some implementations, the first cement board layer and the second cement board layer can be attached to the first sheet metal member via one or more fasteners. In some implementations, the one or more gypsum board layers can include two fiberglass sheathed gypsum board layers.

Some implementations can include a demising wall, having an insulation section, a first gypsum board layer installed on a first side of the insulation section, and a second gypsum board layer installed over on a second side of the insulation section, opposite the first side of the insulation section. The demising wall can also include a first plurality of hat channels coupled to the first gypsum board layer, a second plurality of hat channels coupled to the second gypsum board layer, first finish panels coupled to the first plurality of hat channels via first trim pieces, and second finish panels coupled to the second plurality of hat channels via second trim pieces.

In some implementations, the demising wall can also include a first sheet metal member installed on an interior surface of the first gypsum board layer between the insulation section and the first gypsum board layer, and a second sheet metal member disposed on an interior surface of the second gypsum board layer between the insulation section and the second gypsum board layer.

In some implementations, the first gypsum board layer can include fiberglass sheathed gypsum board, and wherein the second gypsum board layer can include fiberglass sheathed gypsum board.

Some implementations can include a utility wall, having an insulation section, an insulation board installed on a first side of the insulation section, a first gypsum board layer installed over the insulation board on the first side of the insulation section, and a second gypsum board layer installed on a second side of the insulation section, opposite the first side of the insulation section. The utility wall can also include a weather resistive barrier installed over the first gypsum board layer, and a vapor retardant layer installed over the second gypsum board layer.

In some implementations, the utility wall can include one or more furring members coupled to an exterior of the utility wall over the weather resistive barrier, and one or more external finish panels coupled to the one or more furring members. Some implementations can include one or more hat channel members coupled to the second gypsum board layer, one or more trim pieces corresponding to the one or more hat channel members, and one or more interior finish panels coupled to the utility wall via the trim pieces. In some implementations, the insulation section can include a plurality of insulation layers.

Some implementations can include an end wall having an insulation section, a thermal insulation layer installed on a first side of the insulation section, a first gypsum board layer installed on a side of the thermal insulation layer opposite the insulation section, and a weather resistant barrier installed on a side of the first gypsum board layer opposite the thermal insulation layer. The end wall can also include a second gypsum board layer installed on a second side of the thermal insulation layer opposite the first side of the thermal insulation layer, and a vapor retardant layer installed on an interior surface of the second gypsum board layer between the second gypsum board layer and the insulation section.

In some implementations, the end wall can also include a first sheet metal layer installed on an interior surface of the thermal insulation layer between the thermal insulation layer and the insulation section, and a second sheet metal layer installed on an interior surface of the second gypsum board layer between the second gypsum board layer and the insulation section.

In some implementations, the end wall can also include one or more hat channel members coupled to the second gypsum board layer, one or more interior finish panels coupled to the hat channel members via corresponding trim pieces, and insulation installed in a space defined by the second gypsum board layer, the one or more hat channel members, and the interior finish panels.

Some implementations can include a corbel beam having a hollow structural section beam, and a wide flange beam disposed within the hollow structural section beam. The hollow structural section beam can be filled with grout so as to surround the wide flange beam disposed within the hollow structural section beam.

In some implementations, the corbel beam can include a plate installed within the hollow structural section beam and adjacent a flange of the wide flange beam within the hollow structural section beam.

### BRIEF DESCRIPTION OF THE DRAWINGS

FIG. 1 is a cross sectional view of an example floor panel in accordance with some implementations.

FIG. 2 is a cross sectional view of an example roof panel in accordance with some implementations.

FIG. 3 is a cross sectional view of an example demising wall in accordance with some implementations.

FIG. 4 is a cross sectional view of an example demising wall at a doorway in accordance with some implementations.

FIG. 5 is a cross sectional view of an example end wall in accordance with some implementations.

FIG. 6 is a cross sectional view of an example utility wall in accordance with some implementations.

FIG. 7 is a cross sectional view of an example window wall in accordance with some implementations.

FIG. 8 is a cross sectional view of an example corbel beam at a demising wall/utility wall interface in accordance with some implementations.

FIG. 9 is a cross sectional view of an example corbel beam at a demising wall/window wall interface in accordance with some implementations.

FIG. 10 is a cross sectional view of an example corbel beam at an end wall/utility wall interface in accordance with some implementations.

FIG. 11 is a cross sectional view of an example corbel beam at an end wall/window wall interface in accordance with some implementations.

FIG. 12 is a cross sectional view of an example demising wall at a utility wall in accordance with some implementations.

FIG. 13 is a cross sectional view of an example demising wall at a window wall in accordance with some implementations.

FIG. 14 is a cross sectional view of an example end wall at a utility wall in accordance with some implementations.

FIG. 15 is a cross sectional view of an example end wall at a window wall in accordance with some implementations.

FIG. 16 is a cross sectional view of an example window wall at a floor panel in accordance with some implementations.

FIG. 17 is a cross sectional view of an example end wall at a floor panel in accordance with some implementations.

FIG. 18 is a cross sectional view of an example utility wall at a floor panel in accordance with some implementations.

FIG. 19 is a cross sectional view of an example corbel beam at a floor panel and demising wall junction in accordance with some implementations.

FIG. 20 is a cross sectional view of an example floor panel in accordance with some implementations.

FIG. 21 is a cross sectional view of an example floor panel in accordance with some implementations.

FIG. 22 is a cross sectional view of an example interior corridor in accordance with some implementations.

FIGS. 23A and 23B show example utility wall connections in accordance with some implementations.

FIG. 24 shows an example corbel beam at a demising wall and end wall in accordance with some implementations.

FIG. 25 shows an example corbel beam at a demising wall and utility wall in accordance with some implementations.

FIG. 26 shows an example corbel beam at an end wall and window wall in accordance with some implementations.

FIG. 27 shows an example entry door section at a utility wall in accordance with some implementations.

FIG. 28 shows an example entry door in accordance with some implementations.

FIG. 29 shows details of an example entry door jamb in accordance with some implementations.

FIG. 30 shows an example ceiling access door blocking in accordance with some implementations.

FIG. 31 shows an example shower drain and ceiling access door in accordance with some implementations.

FIG. 32 shows an example utility wall at a unit entry door in accordance with some implementations.

FIG. 33 shows an example bedroom wall door jamb in accordance with some implementations.

FIG. 34 shows a cut away view of an example of a bathroom demising wall in accordance with some implementations.

FIG. 35 shows an exploded view of the example kitchen demising wall of FIG. 34 in accordance with some implementations.

FIG. 36 shows a cut away view of an example bathroom end wall in accordance with some implementations.

FIG. 37 shows an exploded view of the example kitchen demising wall of FIG. 36 in accordance with some implementations.

FIG. 38 shows an isometric view of an example middle floor panel in accordance with some implementations.

FIG. 39 shows an exploded view of the example middle floor panel of FIG. 38 in accordance with some implementations.

FIG. 40 shows an isometric view of an example bathroom floor panel in accordance with some implementations.

FIG. 41 shows an exploded view of the example bathroom wall floor panel of FIG. 40 in accordance with some implementations.

FIG. 42 shows an isometric view of an example window wall floor panel in accordance with some implementations.

FIG. 43 shows an exploded view of the example window wall floor panel of FIG. 42 in accordance with some implementations.

FIG. 44A shows an isometric view of an example door utility wall panel in accordance with some implementations.

FIG. 44B shows an exploded view of the example door utility wall panel of FIG. 44A in accordance with some implementations.

FIG. 45A shows an isometric view of an example kitchen utility wall panel in accordance with some implementations.

FIG. 45B shows an exploded view of the example kitchen utility wall panel of FIG. 45A in accordance with some implementations.

FIG. 46A shows an isometric view of an example bathroom utility wall panel in accordance with some implementations.

FIG. 46B shows an exploded view of the example bathroom utility wall panel of FIG. 46A in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are contemplated herein.

This disclosure is drawn, inter alia, to methods, systems, products, devices, and/or apparatuses generally related to modular building systems and components including floor panels, demising walls, end walls, utility walls, and window walls. The embodiments address, among other things, the factors described above and other considerations that are pushing more and more of the construction processes to be completed off-site and to happen in more of a manufacturing environment than a construction site environment.

In some embodiments, a building may have units, residences, rooms, etc. that have pre-manufactured modular wall, ceiling and floor panels. In some embodiments, when the building is being constructed, the wall, ceiling and floor panels may be installed. The wall, ceiling and floor panels may provide a portion of an interior and/or exterior of the building. In some embodiments, the wall, ceiling and floor panels may be coupled to one or more structural frame members of the building. In some embodiments, the wall, ceiling and floor panels may be attached to structural frame members, such as the corbel beams described herein.

In some embodiments, the material composition of the wall, ceiling and floor panels and/or corbel beams may include steel. In some embodiments, the material composition may include aluminum. In still other embodiments, the wall, ceiling and floor panels may be made from a variety of building suitable materials ranging from metals and/or metal alloys, to wood and wood polymer composites (WPC), wood based products (lignin), other organic building materials (bamboo) to organic polymers (plastics), to hybrid materials, earthen materials such as ceramics, or any other suitable materials or combinations thereof. In some embodiments, cement, grout, or other pourable or moldable building materials may also be used. In other embodiments, any combination of suitable building material may be combined by using one building material for some elements of the wall, ceiling and floor panels and other building materials for other elements of the wall, ceiling and floor panels. Selection of any material may be made from a reference of material options (such as those provided for in the International Building Code), or selected based on the knowledge of those of ordinary skill in the art when determining load bearing requirements for the structures to be built. Larger and/or taller structures may have greater physical strength requirements than smaller and/or shorter buildings. Adjustments in building materials to accommodate size of structure, load, and environmental stresses can determine optimal economical choices of building materials used for components in the wall, ceiling and floor panels described herein. Availability of various building materials in different parts of the world may also affect selection of materials for building the system described herein. Adoption of the International Building Code or similar code may also affect choice of materials.

Any reference herein to “metal” includes any construction grade metals or metal alloys as may be suitable for fabrication and/or construction of the wall, ceiling and floor panels, corbel beam, and/or components thereof described herein. Any reference to “wood” includes wood, wood laminated products, wood pressed products, wood polymer composites (WPCs), bamboo or bamboo related products, lignin products and any plant derived product, whether chemically treated, refined, processed or simply harvested from a plant. Any reference herein to “concrete” or “grout” includes any construction grade curable composite that includes cement, water, and a granular aggregate. Granular aggregates may include sand, gravel, polymers, ash and/or other minerals.

Some implementations can permit users to construct an apartment or hotel with a kit of manufactured components (e.g., wall, ceiling and floor panels) that can help reduce labor costs, reduce time for completion, and reduce first cost. Some implementations of a modular building system can include a kit of components that are sufficiently flexible to meet many different requirements, e.g., the same system can be used to make bedroom walls, living room walls, kitchen walls, and bathroom walls.

Some implementations of the manufactured systems described herein can meet the above requirements, among other things. In some implementations, a foundation of the finishes can include a cold formed steel hat channel that can be attached to any standard wall (e.g., a demising wall). The face of the hat channel can carry a simple aluminum extrusion or fiberglass reinforced pultrusion. A pultrusion is a member having a constant cross section and formed by a continuous process for manufacture of composite materials with constant cross-section, where the process involves the pulling of material. The extrusion or pultrusion can permit a very wide range of finishes to be attached to the wall and removed from the wall, and can provide a finish system that can be repaired with few or no tools. In some implementations, a closure extrusion simply captures the panel edge and snaps into the hat channel extrusion. In some implementations, panels can be various sizes and thicknesses. In some implementations, the wall system can include shelf brackets. In some implementations, the same extrusion and pultrusion slightly modified can be used in the bathroom for shower walls, bathroom walls, etc.

Some implementations can include a flexible design that accommodates many different finish material types. For example, wood, metal, and quartzite all can be accommodated. Some implementations can include low cost standardized components.

Using an implementation, apartment or hotel room walls can be constructed with a few different configurations resulting in large scale, low cost manufacturing techniques. In some implementations, wet or dry systems allow shower walls and living room walls to be accommodated with the same standardized components.

Some implementations can include an accessible design that permits electrical devices, plumbing pipes, and HVAC duct work to be easily accessed behind the finished panel system. In some implementations, the snap closure angles can include drilled holes (e.g., at 12 inches on center) to permit hanging televisions, paintings, etc. Some implementations can include a vertical shelf extrusion that permits placement of shelving, cabinets, and countertops.

As designers and builders search for lower cost ways to meet the built environment needs of people, one of the potential solutions is an integrated solution. An integrated solution can include two (or more) components that are traditionally separate products and installations to be integrated into one product solution. Some implementations of the manufactured wall, ceiling and floor panels described herein include an integrated solution that provides a modular building system.

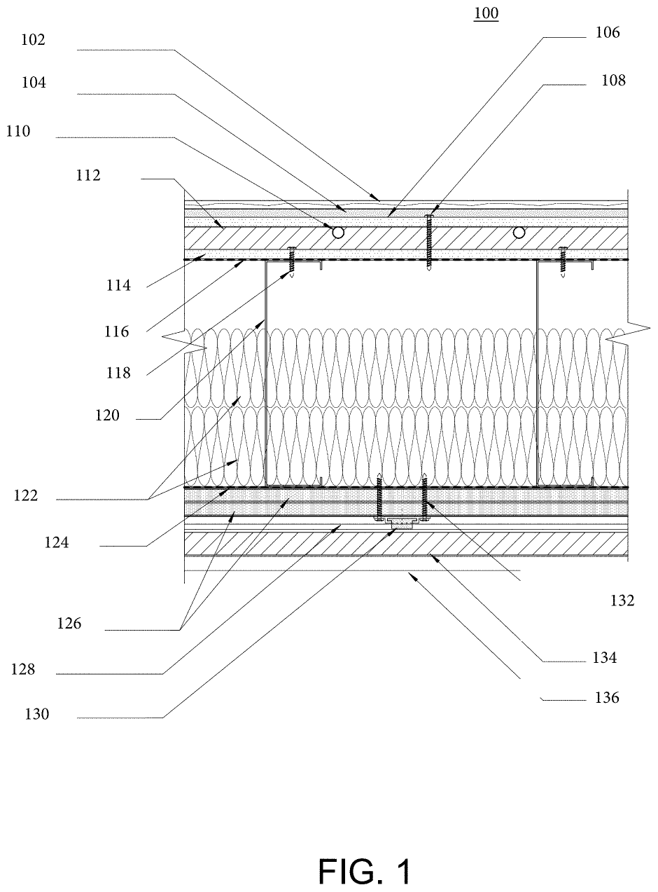

FIG. 1 is a cross sectional view of an example floor panel 100 in accordance with some implementations. The floor panel 100 is constructed to form the floor of an upper unit and a ceiling of a lower unit (e.g., the floor of an apartment unit on a given floor and the ceiling of an apartment unit on a floor immediately below the given floor). The floor panel 100 includes a plurality of layers. In the description of layers and other components herein, reference is made to field panel installed, field finish installed and factory installed. In some implementations, field panel installed can refer to panels that are installed in the field by a panel erection crew (e.g., at a building site to install panels in a building) during a construction process. In some implementations, field finish installed can refer to layers or components that are installed in the field by a finish crew (e.g., at a building site on panels that have been installed in a building) during a construction process. In some implementations, factory installed can refer to layers or components that are installed in a factory setting during a manufacturing process, where the factory setting is different from the field or building site setting.

The floor panel 100 layers include, from top to bottom relative to the floors of a building, a finished flooring layer 102 (e.g., a ⅜″ finished floor that is field finish installed), an acoustical mat layer 104 (e.g., a ⅜″ acoustical mat that is field finish installed), a first cement board layer 106 (e.g., a ½″ cement board layer that is factory installed), a hydronic foam layer 112 (e.g., a 1″ hydronic foam layer that is factory installed) with hydronic piping 110 within the hydronic foam layer 112, a second cement board layer 114 (e.g., a ½″ cement board layer that is factory installed), and a first sheet metal layer 116 (e.g., a 22 ga galvanized steel sheet metal layer that is factory installed).

At the factory, the first cement board layer 106 is secured to the first sheet metal layer 116 using first fasteners 108 (e.g., #8×2.375″ self drilling screws at 12″ on center max). Also at the factory, the second cement board layer 114 is attached to the first sheet metal layer 116 via second fasteners 118 (e.g., #8×1¼″ self drilling screws).

Now, proceeding from the bottom of the floor panel 100 upwards, the layers include an aluminum light rail 136 (that is factory installed) extending below a ceiling panel layer 134 (e.g., a 1″ acoustical ceiling panel tile that is field finish installed) that is held in place by a track 128 (e.g., a pultrusion track that is factory installed) that is attached via a track clip 130 (e.g., an aluminum track clip that is field finish installed). Above the track clip 130 are one or more gypsum board layers 126 (e.g., two ⅝″ type ‘X’ fiberglass mat gypsum sheathing boards that are factory installed with staggered joints). The track clip 130 is attached to the one or more gypsum board layers 126 via third fasteners 132 (e.g., #6×1.1875″ self drilling screws).

Above the one or more gypsum board layers 126 is a second sheet metal layer 124 (e.g., a 22 ga galvanized steel sheet metal layer that is factory installed). The third fasteners 132 also extend through the second sheet metal layer 124.

The first sheet metal layer 116 and the second sheet metal layer 124 are joined by at least one metal joist 120 (e.g., a 10″ 14 ga metal joist with a 2½″ flange that is factory installed). Also, disposed in the space between the first sheet metal layer 116 and the second sheet metal layer 124 is one or more insulation layers 122 (e.g., two layers of 3½″ semi-rigid mineral wool batt insulation that are factory installed).

Thus for the floor panel 100, in some implementations, the layers or components that are field finish installed include the finished floor 102, acoustical mat 104, track clip 130, and ceiling panels 134. The remaining layers and components of the floor panel 100 may be factory installed to minimize labor in the field.

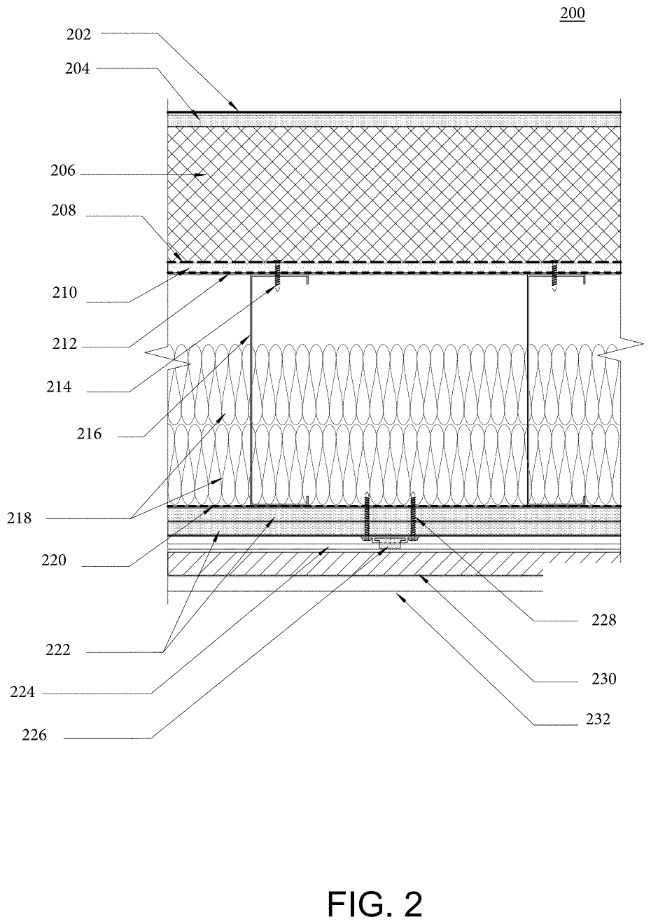

FIG. 2 is a cross sectional view of an example roof panel 200 in accordance with some implementations. The roof panel 200 would form the topmost horizontal panel in a building and comprise the ceiling panel of a top floor unit from the interior and the roof from the exterior of the top of the building. The roof panel 200 includes a plurality of layers.

Beginning from the top, exterior inward, the layers making up the roof include a roofing layer 202 (e.g., a single ply roofing membrane layer), a protection board layer 204 (e.g., a ½″ protection board layer), and a roof insulation layer 206 (e.g., a rigid insulation layer). In some implementations, the roof insulation and roof membrane can be field installed.

Continuing inward from the roof, the layers include a vapor retarder layer 208, a cement board layer 210 (e.g., a ½″ cement board that is factory installed), and a first sheet metal layer 212 (e.g., a 22 ga galvanized steel sheet metal layer). First fasteners 214 are used to attach the vapor retarder layer 208 and the cement board layer 210 to the first sheet metal layer 212.

Proceeding from the bottom of the roof panel 200 upwards, the layers include an aluminum light rail 232 (that is factory installed) extending below a ceiling panel layer 230 (e.g., a 1″ acoustical ceiling panel tile that is field finish installed) that is held in place by a track 224 (e.g., a pultrusion track that is factory installed) that is attached via a track clip 226 (e.g., an aluminum track clip that is field finish installed). Above the track clip 226 are one or more gypsum board layers 222 (e.g., two ⅝″ type ‘X’ fiberglass mat gypsum sheathing boards that are factory installed with staggered joints). The track clip 226 is attached to the one or more gypsum board layers 222 via second fasteners 228 (e.g., #6×1.1875″ self drilling screws).

Above the one or more gypsum board layers 222 is a second sheet metal layer 220 (e.g., a 22 ga galvanized steel sheet metal layer that is factory installed). The second fasteners 228 also extend through the second sheet metal layer 220.

The first sheet metal layer 212 and the second sheet metal layer 220 are joined by at least one metal joist 216 (e.g., a 10″ 14 ga metal joist with a 2½″ flange that is factory installed). Also, disposed in the space between the first sheet metal layer 212 and the second sheet metal layer 220 are one or more insulation layers 218 (e.g., two layers of 3½″ semi-rigid mineral wool batt insulation that are factory installed).

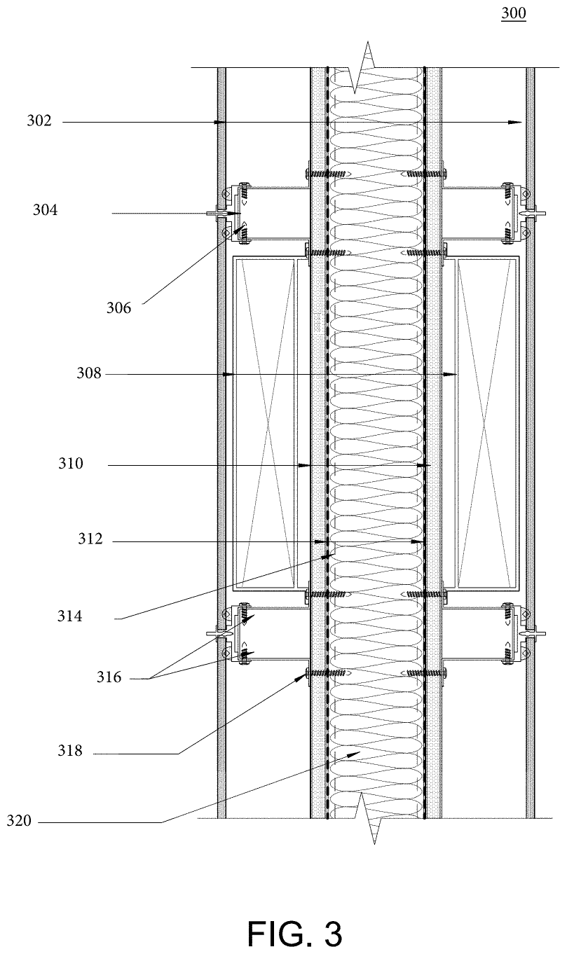

FIG. 3 is a cross sectional view of an example demising wall 300 in accordance with some implementations. A demising wall can include a wall forming a boundary that separates one tenant's space from that of another tenant and from a common corridor. A demising wall is also called a demising partition or party wall.

The demising wall 300 includes a plurality of layers and components. From exterior to interior on a first side, the layers include one or more interior finish panels 302 (e.g., a manufactured prefinished interior panel that is about 1′4″ high and is field finish installed). The interior finish panels 302 are held in place via a trim piece 304 (e.g., a fiberglass reinforced plastic pultrusion trim that is field finish installed) that includes an exterior portion and an interior portion. The interior portion of the of the trim piece 304 is attached to a hat channel 306 (e.g., a 2½″ deep by 2″ wide 20 ga hat channel with 1″ legs at 16″ on center). The hat channel 306 is screwed into a gypsum board layer 310 (e.g., a ⅝″ type ‘X’ fiberglass mat gypsum sheathing board) and on into a sheet steel 312 layer (e.g., 22 ga galvanized sheet steel) using fasteners 318. Within a space provided by the standoff of the hat channel 306 from the gypsum board layer 310, a duct 308 (e.g., a ⅛″ fiberglass reinforced plastic pultrusion duct) can be placed. In some implementations, the duct can be exhaust for kitchen, bathroom, dryer or incoming fresh air.

On a second side of the demising wall 300 opposite the first side, a mirror image set of the layers and components described above is provided. In the space between the first and second sides of the demising wall 300 are metal studs 314 (e.g., 3⅝″ 25 ga metal studs at 24″ on center). The fasteners 318 can extend through the sheet metal layer (e.g., 312) and into the metal stud 314. Also disposed in the space between the first and second sides of the demising wall 300 is an insulation layer 320 (e.g., 3½″ semi-rigid mineral wool batt insulation that is factory installed).

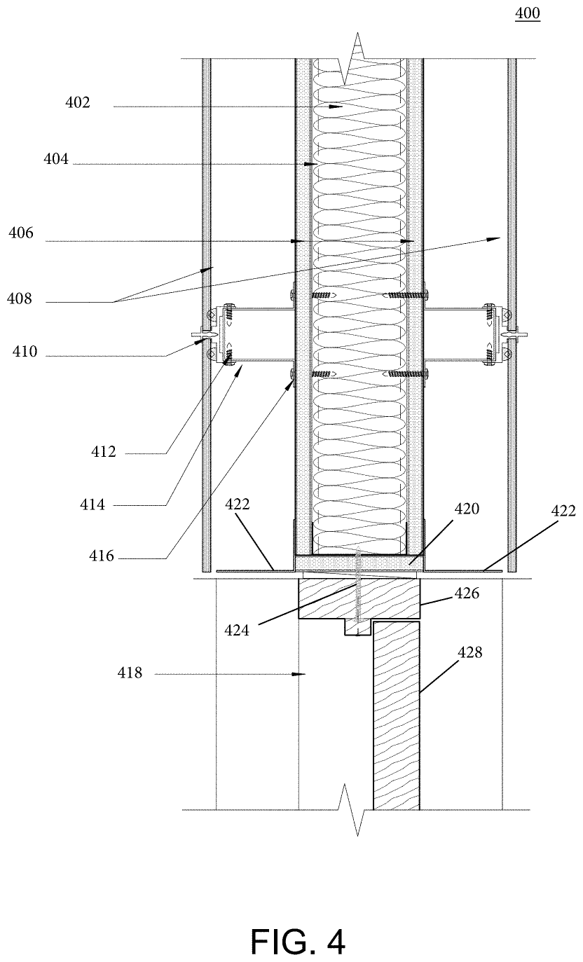

FIG. 4 is a cross sectional view of an example demising wall 400 at a doorway in accordance with some implementations. The demising wall 400 shown in FIG. 4 includes a bedroom wall at a doorway to a bedroom. The section view is of a horizontal section of the demising wall adjacent the doorway.

The demising wall 400 includes an insulation layer 402 (e.g., 3½″ semi-rigid mineral wool batt insulation that is factory installed) and one or more metal studs 404 (e.g., a 3⅝″ 25 ga metal studs factory installed at 24″ on center). The demising wall 400 also includes two gypsum board layers 406 one disposed on each side of the demising wall 400. The gypsum board layers 406 can include a 5/8″ type ‘X’ fiberglass matt gypsum sheathing board.

The demising wall 400 also includes interior finish panels 408 disposed on each side of the demising wall 400. The interior finish panels 408 can be field installed and can be held in place by one or more trim pieces 410 (e.g., fiberglass reinforced plastic pultrusion trim).

The demising wall 440 also includes a hat channel 414 to which the trim pieces 410 are attached to via first fasteners 412 (e.g., #8½″ screws at 48″ on center). The hat channel 414 is attached to the gypsum board layer 406 via second fasteners 416 (e.g., #8 1⅝″ screws at 24″ on center). The demising wall 400 includes a door opening 418.

The demising wall 400 includes an end cap member 420 and trim pieces 422 (e.g., angled metal trim) that cover the gap created by the hat channels 414 between the gypsum board layers 406 and the finish panels 408. A door jamb 426 is coupled to the demising wall via a fastener 424. A door 428 is installed in the door opening 418.

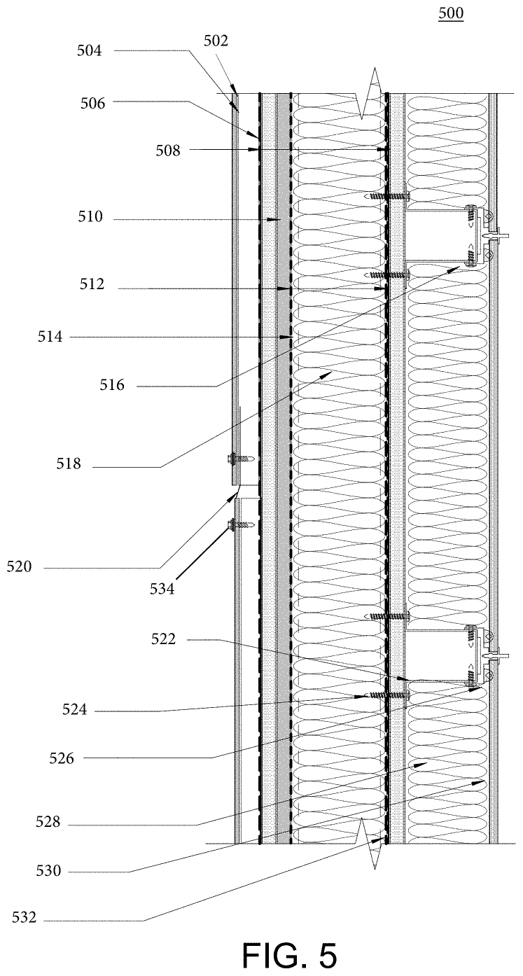

FIG. 5 is a cross sectional view of an example end wall 500 in accordance with some implementations. The end wall 500 can form an exterior wall of a unit (e.g., a wall that is an interior wall on one side and an exterior wall on an opposite side) or an interior wall.

The end wall 500 can include a plurality of layers and components. The layers and components can include—generally from the exterior to the interior—a factory installed exterior panel 502 (e.g., a 4 mm aluminum composite material panel that is factory installed), a furring member 504 (e.g., a 1″ extruded aluminum furring that is factory installed), a weather resistive barrier layer 506 (factory installed), first and second gypsum board layers 508 (e.g., ⅝″ ‘X’ type fiberglass matt sheathing board), a first thermal insulation layer 510 (e.g., ½″ thermal insulating material adhered to stud and factory installed), first and second sheet metal layers 512 (e.g., 22 ga galvanized sheet steel screwed into studs at 12″ on center and factory installed), metal studs 514 (e.g., 3⅝″ 18 ga metal stud at 24″ on center), and a second insulation layer 518 (e.g., 3½″ semi rigid mineral wool batt insulation, factory installed).

A drip flashing 520 (e.g., a pre-finished aluminum drip flashing) can be factory installed at the joints between the exterior finish panels 502. A vapor retarder layer 532 can be factory installed between the second insulation layer 518 and the second gypsum board layer 508 (e.g., the interior gypsum board layer).

Continuing on from exterior to interior, a plurality of hat channels 522 are factory installed on the second gypsum board layer 508 using second fasteners 524. Third insulation 528 is field finish installed in the end wall 500. Trim 526 is field finish installed and attached to the hat channel 522 via first fasteners 516.

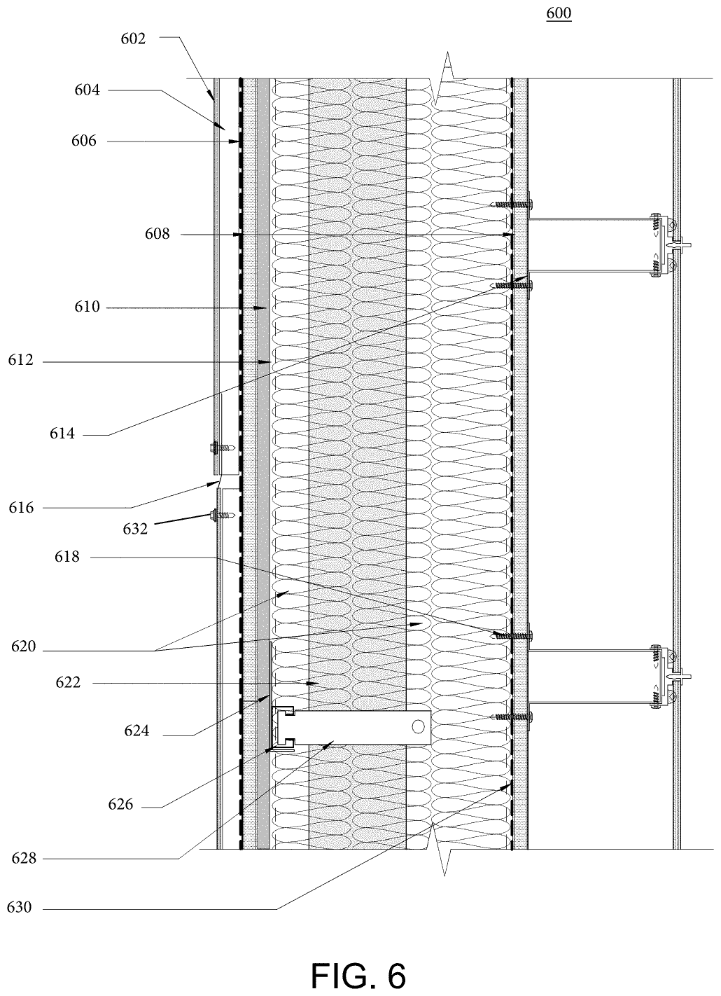

FIG. 6 is a cross sectional view of an example utility wall 600 in accordance with some implementations. The utility wall 600 can form an exterior wall of a unit (e.g., a wall that is an interior wall on one side and an exterior wall on an opposite side) or an interior wall.

The utility wall 600 includes a plurality of layers and components. The layers and components can include—generally from the exterior to the interior—a factory installed exterior panel 602 (e.g., a 4 mm aluminum composite material panel that is factory installed), a furring member 604 (e.g., a 1″ extruded aluminum furring that is factory installed), a weather resistive barrier layer 606 (factory installed), first and second gypsum board layers 608 (e.g., ⅝″ ‘X’ type fiberglass matt sheathing board), and a first thermal insulation layer 610 (e.g., ½″ thermal insulating material adhered to stud and factory installed).

The utility wall 600 can also include a plurality of metal studs 612 (e.g., 10″ 18 ga metal studs), and second, third, and fourth insulation layers 620 (e.g., 3½″ mineral wool batt insulation, factory installed).

A drip flashing 616 (e.g., a pre-finished aluminum drip flashing) can be factory installed at the joints between the exterior finish panels 602. A vapor retarder layer 630 can be factory installed between the third insulation layer 620 and the second gypsum board layer 608 (e.g., the interior gypsum board layer).

Continuing on from exterior to interior, a plurality of hat channels 614 are factory installed on the second gypsum board layer 608 using first fasteners 618. Trim is field finish installed and attached to the hat channel. The trim is used to hold interior finish panels in place.

The utility wall 600 can include piping 622 (e.g., factory installed piping for waste water, supply water, exhaust, venting, electrical boss and feeder cables, etc.) held in place by a pipe bracket 628 coupled to a unistrut 626 inserted into a knockout 624 in the stud 612, all factory installed.

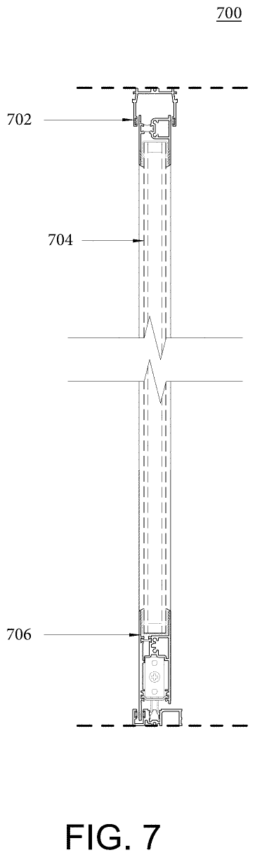

FIG. 7 is a cross sectional view of an example window wall 700 in accordance with some implementations. The window wall 700 includes, among other things, an upper thermally broken frame 702 (e.g., a thermally broken aluminum frame), clear or fritted glass 704, and a lower thermally broken frame 706 (e.g., a thermally broken aluminum frame).

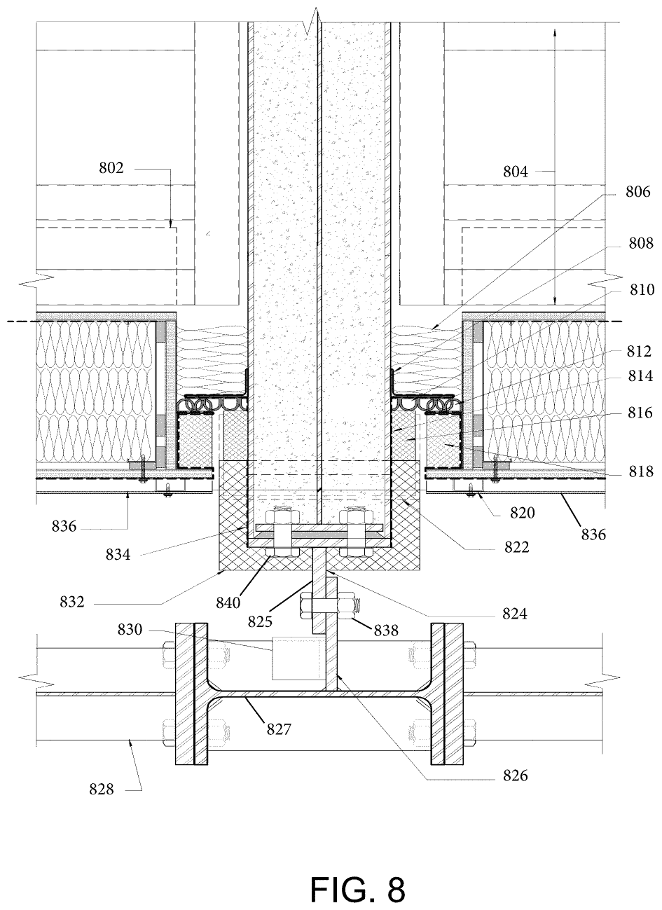

FIG. 8 is a cross sectional view of an example corbel beam at a demising wall/utility wall interface in accordance with some implementations. In particular, FIG. 8 shows a horizontal cross section at an area where a corbel beam 834 attaches to a structural member, e.g., a wide flange steel column 827 that forms a portion of a building structural framework. The corbel beam 834 attaches to a corbel beam connection plate 825 that is, in turn, connected to a connection plate 826 via one or more bolts 838 to the wide flange steel column 827. A steel tab erection stop 830 (e.g., a 3″×3″×¼″ steel tab) is attached to the connection plate 826 to assist with erection and installation of the corbel beam 834.

The corbel beam 834 is shown in relation to a floor panel 804 and a hat channel 802 above. Also shown are two utility walls 836 (one on each side of the corbel beam 834). Also shown is a corridor beam 828 that connects to the wide flange column 827 and extends horizontally along a corridor to the exterior of the utility walls 836.

The junction where the corbel beam 834 meets the utility walls 836 includes first insulation 806 (e.g., 4″ compressed semi-rigid mineral wool batt insulation that is field finish installed), an angle iron 808 (e.g., a 2″×3″×15½″⅛″ L angle iron) is centered and welded on each side of the corbel beam 834, and an angle gasket 810 (e.g., can be attached to the angle iron in the field prior to corbel beam 834 installation or can be attached in the factory to protect the corbel beam 834 during transit), the utility wall 836 also includes a gasket 812 corresponding to the angle gasket 810. A weather resistant barrier 814 is applied to each side of the corbel beam 834 end and can run up and over angle iron 808.

Second insulation 816 is attached to each side of the end of the corbel beam 834 (e.g., 1″ semi-rigid mineral wool insulation board adhered in a factory to each side of the corbel beam 834). On the utility wall 836 end that meets the corbel beam 834 end, there is attached a third insulation material 818 (e.g., 2″ semi-rigid mineral wool insulation board adhered to the utility wall 836 end in a factory).

The utility walls 836 include a closure member 820 that covers the junction between the utility walls 836 and the corbel beam 834. Above the corbel beam 834, is a demising wall (not shown) that is attached to and supported by the corbel beam 834. A closure end of the demising wall is shown by the dashed lines at 822.

A carbon foam beam cover 832 (e.g., the carbon foam beam cover can include CNC machining at bolts and plates and can be attached in the factory) is attached to the end of the corbel beam 834. A sealant 824 (e.g., a silicone sealant) is applied at the area where the corbel beam 834 connection plate 825 passes through the carbon foam beam cover 832. Bolts 840 connect the corbel beam 834 to the corbel beam connection plates

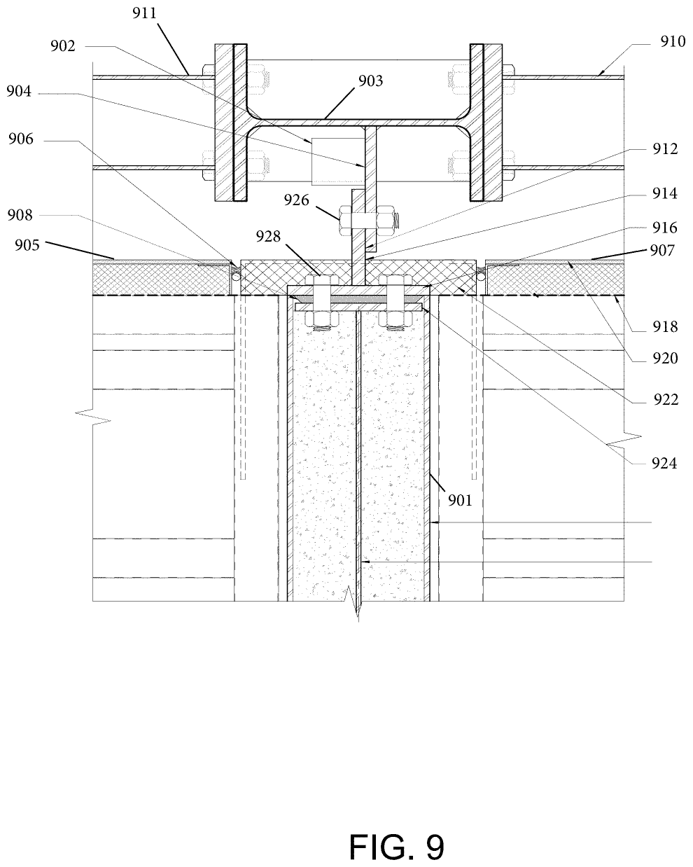

FIG. 9 is a cross sectional view of an example corbel beam at a demising wall/window wall interface in accordance with some implementations. In particular, FIG. 9 shows a corbel beam 901 coupled to a wide flange steel column 903 at a junction where a demising wall (not shown, disposed above and supported by the corbel beam 901) meets two window walls 905 and 907. Also coupled to the wide flange steel column 903 are two balcony beams 910 and 911 extending horizontally to the exterior of the window walls 907 and 905, respectively. An outline of a floor panel edge is shown at the dashed line 918.

A first connection plate 904 is coupled to the wide flange column 903. A steel tab erection stop 902 (e.g., a 3″×3″×¼″ steel tab) is coupled to the first plate 904 to provide a stop point for use during erection of the building and coupling of the corbel beam 901 to the wide flange column 903.

At the end of the corbel beam 901, a cap plate 924 (e.g., a ½″ steel plate cut parallel to an inside radius of the corbel beam 901 and fabricated to be ⅛″ short on all sides, factory installed) is coupled to the corbel beam 901 and is used to secure a second plate 912 to the corbel beam 901 via a third plate 916 (e.g., a ⅝″×8″×16″ steel plate) and a plurality of fasteners 928 (e.g., nut and bolt systems). The first plate 904 is joined to the second plate 912 via a plurality (e.g., 5) of fasteners 926 (e.g., bolt and nut systems).

A beam cover 922 is attached to the end of the corbel beam 901 in the factory. The beam cover 922 can include a carbon foam beam cover with CNC machining at bolts and plates attached to the corbel beam 901). Trim pieces 920 are coupled to an exterior surface of the window walls 905 and 907 at the factory. The corbel beam 901 includes first insulation material 908 (e.g., ½″ thermal insulation material notched at 45 degree angles to accommodate welds, factory installed). At each joint where the window walls 905 and 907 meet the corbel beam 901, a sealant and backer rod 906 is field finish installed.

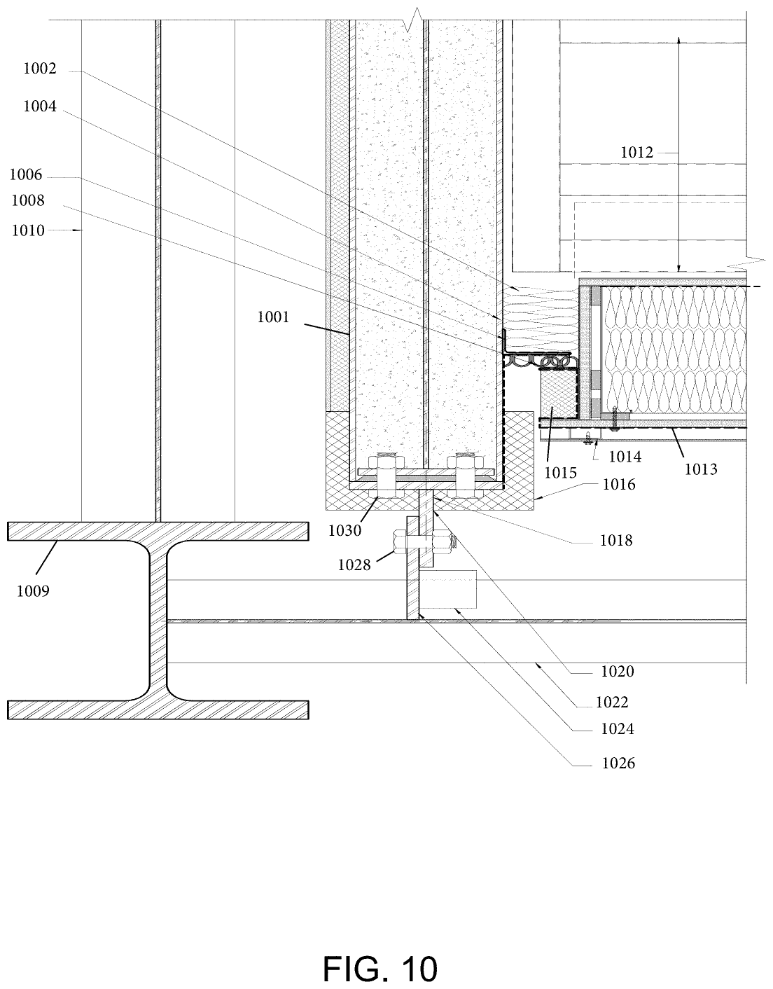

FIG. 10 is a cross sectional view of an example corbel beam at an end wall/utility wall corner interface in accordance with some implementations. In particular, FIG. 10 shows a corbel beam 1001 coupled to a wide flange corridor beam 1022, which is coupled to a structural frame including a wide flange column 1009 and a wide flange beam 1010.

The corbel beam 1001 is disposed below and supports an end wall (not shown) at a corner where the end wall meets with a utility wall 1013. Also shown is the outline of a floor panel 1012 on the interior of the end wall and the utility wall 1013.

The corbel beam 1001 is coupled to the wide flange corridor beam 1022 via a first plate 1018 fastened to the corbel beam end via fasteners 1030 (similar to the end connection of the corbel beam shown FIG. 9 and described above). The first plate 1018 is coupled to a second plate 1026 via one or more fasteners 1028 (e.g., five bolt and nut combinations). The second plate 1026 is coupled (e.g., welded) to the wide flange corridor beam 1022. The second plate 1026 includes an erection stop 1024 coupled to the second plate 1026 (e.g., similar to 902 described above). A beam cover 1016 (e.g., a carbon foam beam cover) is coupled to an end of the corbel beam 1001. A sealant 1020 (e.g., a silicon sealant bead) can be applied in the factory to the seam where the first plate 1018 extends through the beam cover 1016.

First insulation 1002 (e.g., 4″ compressed semi-rigid mineral wool batt insulation that is field finish installed) is disposed at an end of the utility wall 1013 in an area between the corbel beam 1001 and an edge of the utility wall 1013. An angle iron 1004 (e.g., a 2¾″×2¾″×15½″×⅛″ L angle iron) is coupled (e.g., welded) to the corbel beam 1001. The first insulation 1002 is disposed on a first side of the angle iron 1004. On the opposite side of the angle iron 1004 is an angle gasket 1006 that can be installed at the factory to protect the beam or in the field prior to corbel beam installation. The angle gasket 1006 engages with a utility wall gasket 1008 coupled to the utility wall 1013 adjacent to second insulation 1015 coupled to the utility wall 1013 end. The utility wall 1013 includes a closure 1014 on an exterior of the utility wall 1013.

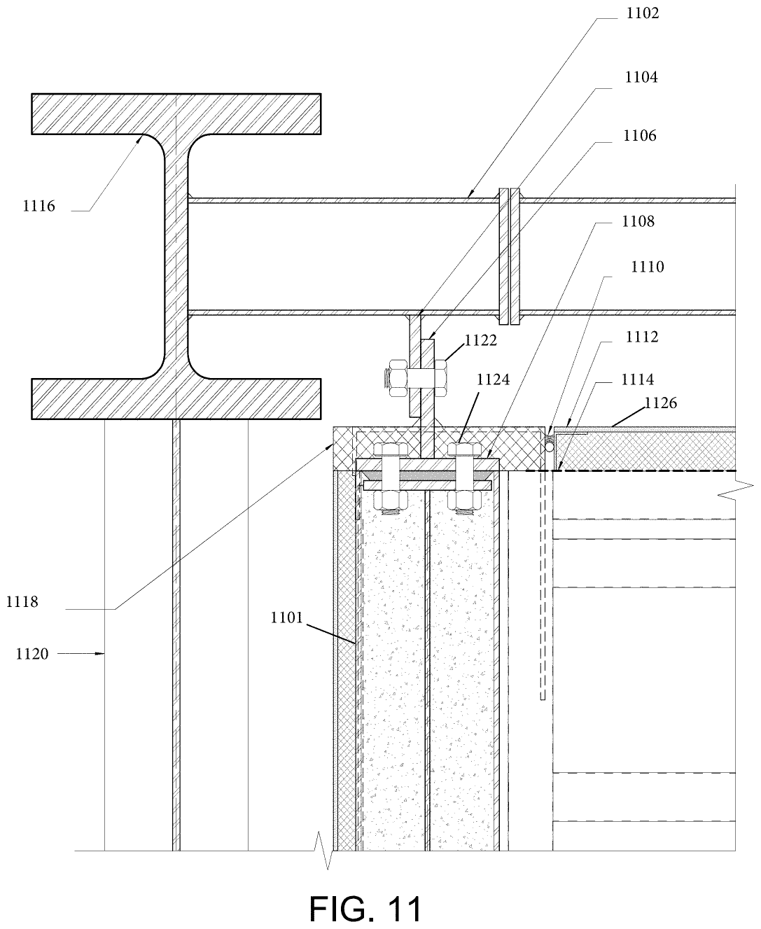

FIG. 11 is a cross sectional view of an example corbel beam at an end wall/window wall interface in accordance with some implementations. In particular, FIG. 11 shows a corbel beam 1101 coupled to a sub cantilever beam 1102 via a first connection plate 1104 and a second connection plate 1106 via one or more fasteners 1122 (e.g., five bolt and but combinations). The second plate 1106 is coupled to the corbel beam 1101 via a third plate 1108 and fasteners 1124 (e.g., similar to that described above in connection with FIG. 9).

The sub-cantilever beam 1102 is coupled to a wide flange steel column 1116, which is in turn coupled to a wide flange beam 1120. A beam cover 1118 (e.g., a carbon foam beam cover machined at bolts and plates of the corbel beam 1101) is coupled to the corbel beam 1101.

FIG. 11 also shows a window wall 1126 and a floor panel outline 1114. An end wall (not shown) is supported by the corbel beam 1101. The window wall 1126 includes a closure member 1112 (e.g., a fiber reinforced polymer (FRP) pultrusion closure installed at the factory). In a joint between the beam cover 1118 and the window wall 1126, a backer rod and sealant 1110 is placed.

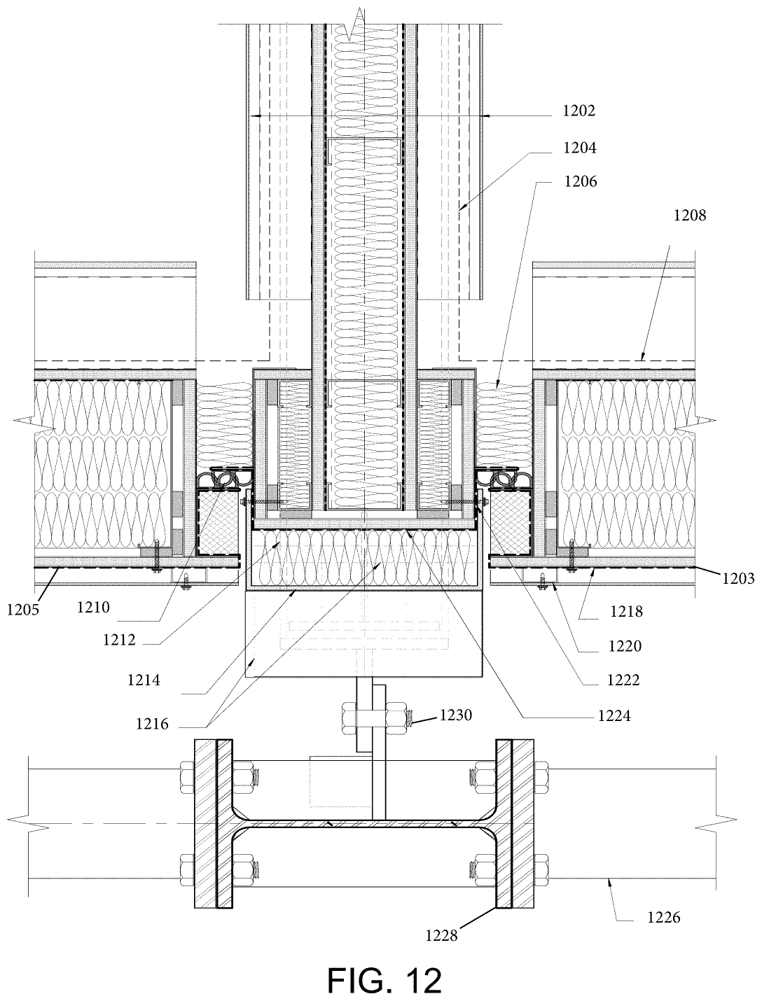

FIG. 12 is a cross sectional view of an example demising wall at a utility wall in accordance with some implementations. In particular, FIG. 12 shows a demising wall 1202 (e.g., similar to 300 described herein) meeting two utility walls 1203 and 1205. A floor panel outline is shown by dashed lines 1204 and 1208. The utility walls 1203 and 1205 can be similar to 600 described herein). The demising wall 1202 is supported from beneath by a corbel beam 1212 below. The corbel beam 1212 is connected to a wide flange steel column 1228 via a corbel beam connection 1230 (as described in greater detail in connection with FIG. 9 herein). The wide flange steel column 1228 is connected to a wide flange corridor beam 1226.

The interface between each side of the demising wall 1202 and a respective utility wall 1203 and 1205 includes insulation 1206 (e.g., 3″ compressed semi-rigid mineral wool batt insulation, field finish installed). Corresponding gaskets 1210 are disposed in the interface area.

A beam cover 1216 (e.g., a carbon foam beam cover) is placed on the end of the corbel beam 1212. A weather resistant barrier 1224 is factory installed over sheathing at an end of the demising wall 1202. A shim 1222 can be used as needed to help ensure a good fit between the demising wall 1202 and the utility walls 1203 and 1205. A weather resistant barrier 1218 can be factory installed over sheathing on the utility walls 1203 and 1205. A closure 1220 can be factory installed on an exterior of each of the utility walls 1203 and 1205 over the weather resistant barrier 1218.

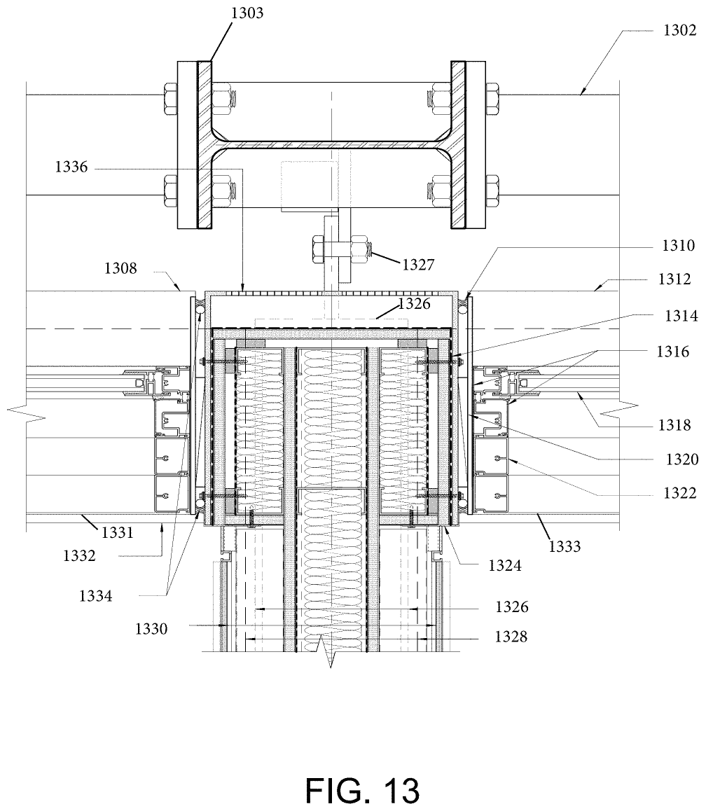

FIG. 13 is a cross sectional view of an example demising wall and window wall interface in accordance with some implementations. In particular, FIG. 13 shows interface details of a demising wall 1330 and two window walls 1331 and 1333. The demising wall 1330 is supported by a corbel beam 1326 below. The corbel beam 1326 is coupled to a wide flange steel column 1303 via a corbel beam connection 1327 as described herein in greater detail in connection with FIG. 9. A balcony beam 1302 is also shown coupled to the wide flange steel column 1303. Also shown in FIG. 13 is the outline of a floor panel below 1328 and a back edge of the floor panel recess 1332.

The window walls, 1331 and 1333, each include a window jamb assembly 1316 (e.g., having ¼″ plate screwed to the demising wall 1330 using #10×3″ flathead screws through sealed pre-drilled holes, field finish installed), a sliding door 1318 (field finish installed), shims 1314 and/or 1320 as necessary (field finish installed), and snap-in jamb fillers 1322 (field finish installed). In a joint between each window wall, 1331 and 1333, and a respective side of the demising wall 1330, sealant and backer rod are installed 1310 and 1334. The window walls 1331 and 1333 also include factory installed flashing 1308 and 1312, respectively. The flashing 1308 and 1312 can include ⅛″ pultruded fiber reinforced polymer material.

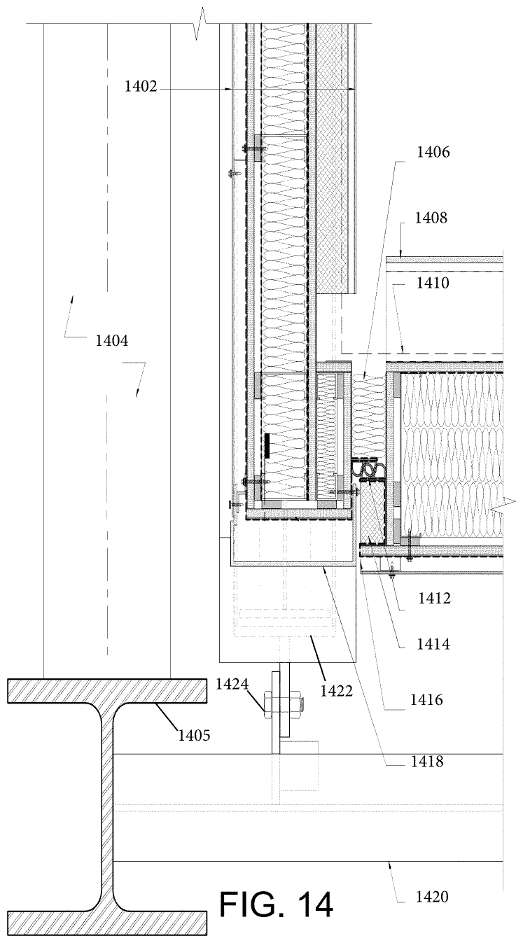

FIG. 14 is a cross sectional view of an example end wall/utility wall corner in accordance with some implementations. In particular, FIG. 14 shows a corner where an end wall 1402 (e.g., similar to 500) meets a utility wall 1408 at a corner. An outline of a floor panel 1410 is shown at the corner. A corbel beam 1422 supports the end wall 1402 and the corbel beam 1422 is coupled to a wide flange corridor beam 1420 via corbel beam plate connection 1424 (described herein, for example in connection with FIG. 9). The wide flange corridor beam 1420 is connected to a wide flange column 1405 that is connected to a wide flange beam 1404 (below).

The corbel beam 1422 supports an end wall 1402 disposed above the corbel beam 1422. The end wall 1402 includes an end wall closure 1422 (e.g., a ¼″ pultruded fiber reinforced polymer closure attached to the end wall 1402 in the factory).

In the space between the end wall 1402 and the utility wall 1408 is installed first insulation 1406 (e.g., 3″ compressed semi-rigid mineral wool batt insulation, field finish installed), a utility wall gasket 1412 (e.g., a gasket provided on the utility wall and configured to contact a corresponding gasket on the end wall 1402), second insulation 1414 (e.g., 2″ semi-rigid mineral wool batt insulation board adhered to the utility wall 1408 in a factory), and a closure 1416 (e.g., an aluminum closure that is factory installed).

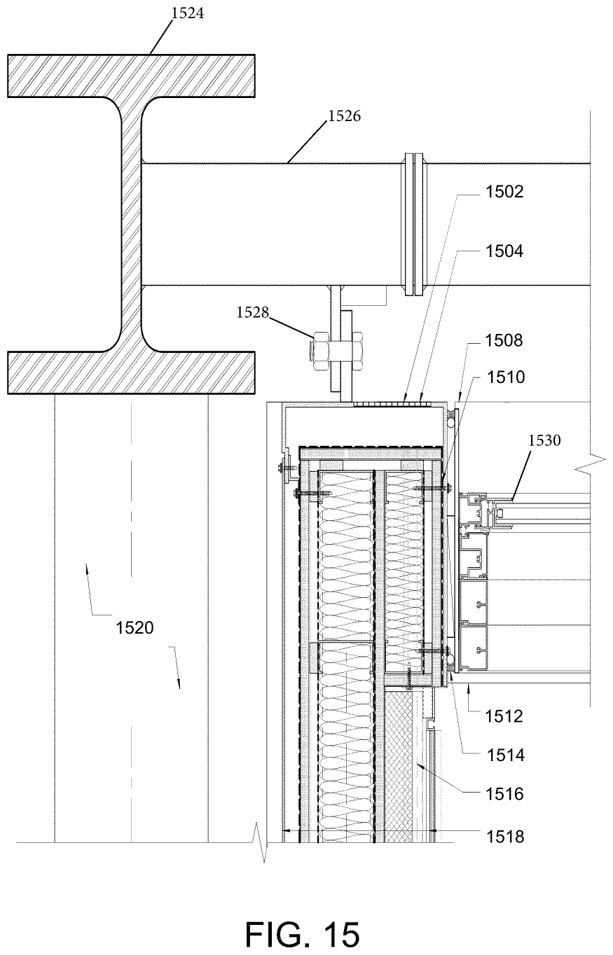

FIG. 15 is a cross sectional view of an example end wall at a window wall in accordance with some implementations. In particular, FIG. 15 shows an end wall 1518 attached to a cantilever beam 1526 via a corbel beam connection 1528 (to a corbel beam, not shown, below the end wall 1518). The cantilever beam 1526 connects to a wide flange steel column 1524, which, in turn, is connected to a wide flange beam 1520. The end wall 1518 meets a window wall 1530 at a corner. An outline of a floor panel 1516 is shown at the corner.

The end wall 1518 includes a closure 1504 (e.g., a ¼″ pultruded FRP closure that is factory installed), an exhaust outlet 1502 (e.g., factory installed in the closure 1504). One or more shims 1510 are used as needed to align the closure 1504 on the end wall 1518. The window wall 1530 includes a flashing 1508 (e.g., a ⅛″ pultruded FRP flashing that is factory installed). A sealant and backer rod 1514 are used to seal the joint where the window wall 1530 and the end wall 1518 meet. FIG. 15 also shows a back edge of a floor panel recess 1512.

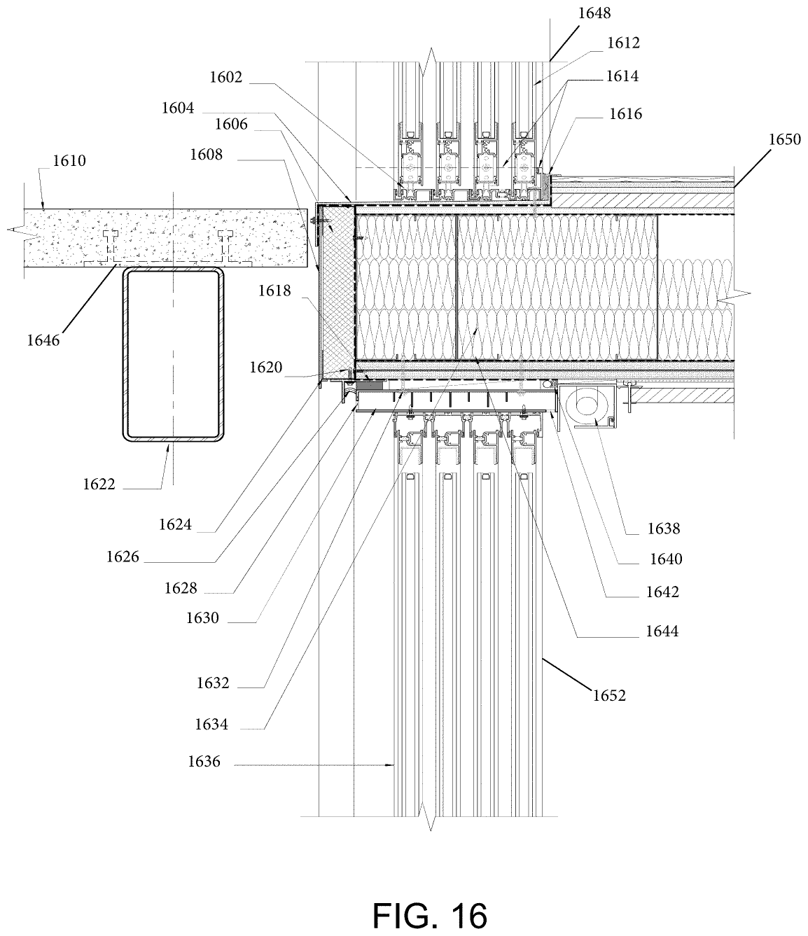

FIG. 16 is a cross sectional view of an example window wall at a floor panel in accordance with some implementations. In particular, FIG. 16 shows details of an intersection where an upper window wall 1648 and a lower window wall 1652 meet a floor panel 1650. A balcony 1610 (e.g., a 4″ lightweight precast concrete balcony) is also shown supported by a balcony beam 1622. The balcony 1610 is attached to the balcony beam 1622 via anchors 1646 embedded within the concrete of the balcony 1610. The balcony 1610 serves as the balcony for the unit corresponding to the upper window wall 1648.

A sliding door (or window) sill assembly 1602 is shimmed as needed and coupled to the floor panel 1650 in the factory above a pan flashing 1604 (e.g., a pre-sloped ⅛″ FRP pultruded pan flashing that is also installed in the factory. first insulation 1606 (e.g., 2″ rigid insulation) is coupled to the end of the floor panel 1650 in the factory and trim 1608 (e.g., ¼″ pultruded FRP trim) is placed over the first insulation 1606.

The window walls 1648 and 1652 each include sliding doors 1612 and 1636, respectively, that are field installed. At the base of the sliding doors 1612 are a backleg and end dams 1614 and a sill trim 1616 (e.g., a stainless steel sill trim is applied with a sealant are field finish installed).

A J-channel 1624 is factory installed over the bottom end of the first insulation 1606. The J-channel 1624 can include a 2″ J-channel with 2″ and 3″ legs with pre-punched ¼″ diameter weeps every 48″ on center (OC). Sealant over bond-break tape 1626 is field finish installed.

An insect screened vent opening 1628 is factory installed. A window head 1630 (e.g., a window head with a baffled trickle vent extrusion) is factory installed on a bottom of the floor panel 1650 using fasteners 1632 (e.g., #10×¾″ washered screws). A free area opening 1642 is provided in the trickle vent (e.g., a 20 sq inch net free area opening in the trickle vent is factory installed).

The floor panel 1650 includes sheet metal 1644 (e.g., 22 ga×19″ sheet steel attached to the first three joists with a #10×1″ FHSD at 24″ OC). The floor panel 1650 also includes second insulation 1634 (e.g., full cavity 3½″ semi-rigid mineral wool batt insulation to third joist, factory installed). Window blinds 1638 are field finish installed adjacent an interior side of the window wall 1652. A sealant and backer rod 1640 is installed above the window head 1630 adjacent the window blinds 1638.

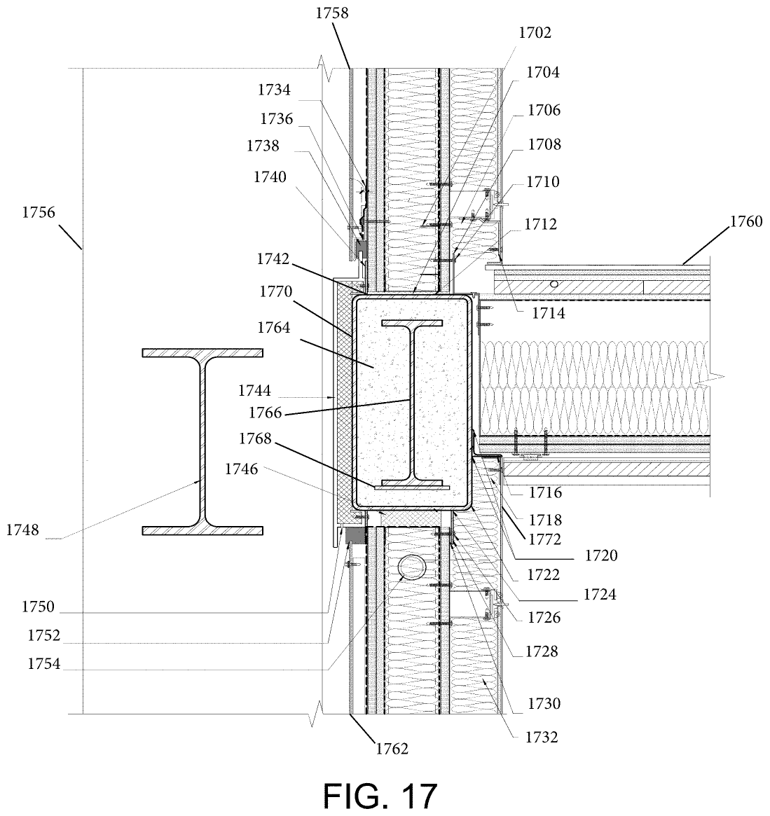

FIG. 17 is a cross sectional view of an example end wall at a floor panel in accordance with some implementations. In particular, FIG. 17 shows details of an area where an upper end wall 1758, a floor panel 1760 and a lower end wall 1762 meet at a corbel beam 1722. Structural members including a wide flange beam 1748 and a wide flange column 1756 (e.g., without fireproofing) are also shown in FIG. 17.

The upper end wall 1758 includes a c-channel metal track 1702 (e.g., a 3⅝″×full length c-channel 18 ga metal track with knock outs at stud locations, factory installed). At the interface between the upper end wall 1758 and the corbel beam 1722 is installed first insulation 1704 (e.g., 4″×¼″ ceramic fiber insulation adhered to the bottom of the upper end wall 1758).

In a space where the upper end wall 1758 meets the floor panel 1760 and behind a base plate, is installed second insulation 1706 (e.g., 1½″ semi-rigid mineral wool batt insulation, field finish installed).

A first angle iron 1708 includes two angle iron pieces (e.g., a 1¾″×3″×14 ga L-angle attached to a 3″×3″×12 ga L-angle via rivets ½″ from edge max at 12″ OC spacing, factory installed) riveted to each other and attached to the upper end wall 1758 and the floor panel 160 via fasteners 1710. One of the angle iron pieces is welded to the corbel beam 1722 via a weld 1712. The upper end wall 1758 includes a base panel bracket and/or base panel 1714 that is field finish installed.

A second angle iron member 1716 (e.g., a 2″×2″×⅛″×23′4″ L-angle) is welded at weld 1720 to an interior side of the corbel beam 1722 to support the floor panel 1760. A third angle iron 1718 (e.g., a 1¼″×2″×18 ga L angle iron) is coupled to an underside of the second angle iron member 1716 (e.g., via 1″ very high bond tape, field finish installed). The third angle iron is coupled to a top interior finish plate 1772 of the lower end wall 1762.

Plates 1728 (e.g., a ⅛″×2½″×23′−4″ steel plate) are welded to each side of the corbel beam 1722. In some implementations, the plates 1728 can include 2½″ legs and 1″ vertical slotted holes at 24″ OC beginning from 8″ from edge of angle and 3½″ from bottom of angle. The top of the lower end wall 1762 is attached to the corbel beam 1722 via the plates 1728. Fasteners 1726 are inserted through the vertical slots on the plates 1728 and into the gypsum board and sheet steel layers of the end wall 1726 (see, e.g., description of FIG. 5 above for details on the end wall 1726 layers). One or more shims 1730 can be used as required for a tight installation of the lower end wall 1762. Third insulation 1732 (e.g., 3″ mineral wool insulation) is installed in the wall panels 1758 and 1762 on an interior side between the gypsum layer and the interior finish panel layer. Fourth insulation 1746 (e.g., 1½″×4″ semi-rigid mineral wool insulation board adhered to top of the end wall in the factory) is installed at the top of the end wall 1746.

Within the end wall 1762 is shown a sprinkler pipe 1754. One or more end walls can include the sprinkler pipe 1754. A gasket 1752 (e.g., a silicone gasket) is factory installed at the junction between the exterior finish panel of the end wall 1762 and the weather resistant barrier.

The corbel beam 1722 includes a hollow structural section (HSS), or tube steel, beam 1770 (e.g., a 16″×8″× 5/16″ HSS beam) surrounding a wide flange beam 1766 and a plate 1768, where the space within the HSS beam 1770 is filled with grout 1764 (e.g., for fireproofing). The tube steel 1770 surrounding the beam 1766 acts as a form for the grout 1764 and is used to attach the floor panels, end walls, etc. to the corbel beam 1722 (e.g., by welding angle iron or plate to the HSS beam 1770 that is then connected to the end walls, floor panels, etc.).

A trim piece 1744 (e.g., ¼″ pultruded FRP trim) is coupled to the corbel beam 1722 in the factory. The trim 1744 includes one or more weeps 1750 (e.g., at 24″ OC, factory installed). A plate 1740 is coupled (e.g., welded at 1742) to the corbel beam 1722. The plate 1740 couples the corbel beam 1722 to the upper end wall 1758. A flashing 1736 (e.g., pultrusion) and sealant 1738 (e.g., a non-curing butyl sealant) is factory installed at an interior space where the trim 1744 extends behind an exterior panel of the upper end wall 1758. A weather resistant barrier 1734 factory installed to lap over top of the flashing 1736.

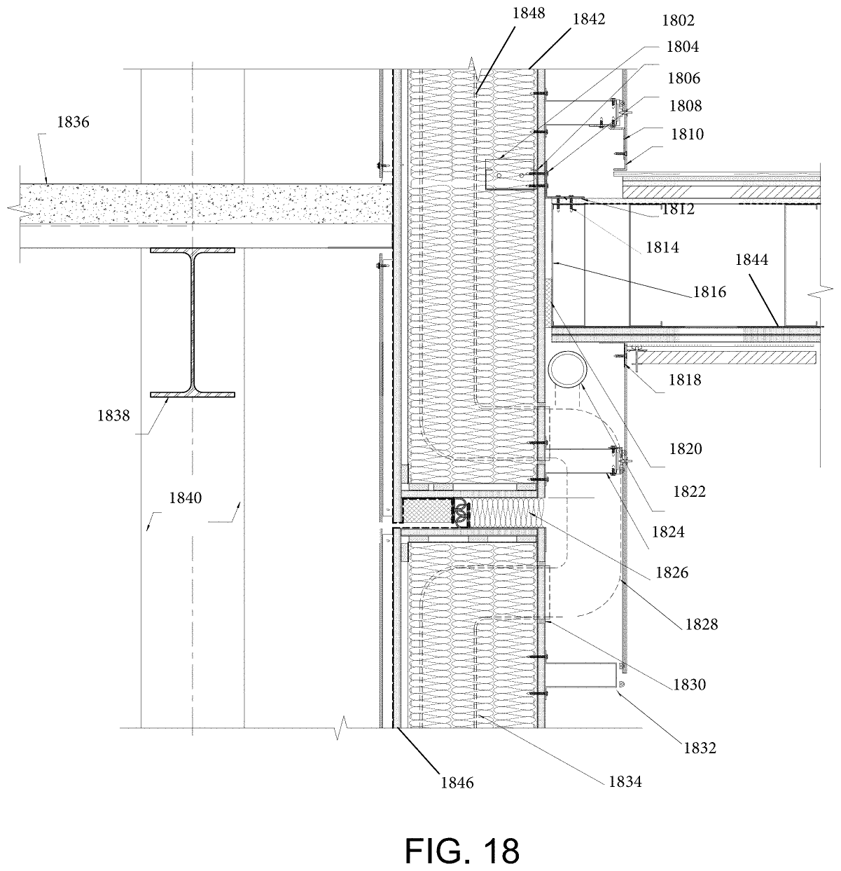

FIG. 18 is a cross sectional view of an example utility wall at a floor panel in accordance with some implementations. In particular, FIG. 18 shows detail of an area where two exterior utility walls, an upper exterior utility wall 1842 and a lower exterior utility wall 1846 meet, and a floor panel 1844 meets the upper exterior utility wall 1842.

The upper utility wall 1842 includes a first angle iron 1802 (e.g., a 2½″×5″×3¾″ angle iron, factory installed) coupled to the upper utility wall 1842 and a metal stud blocking 1804 (e.g., 4″ metal stud blocking between vertical utility wall studs, factory installed) coupled to the upper utility wall 1842 via the utility wall studs.

A second angle iron 1812 (e.g., a 3″×3″×12 ga L angle, factory installed) is coupled at the factory to the upper utility wall 1842 and metal stud blocking 1804 via fasteners 1806 (e.g., #10×1″ hex head self-drilling screws at 6″ OC into predrilled holes, factory installed). The second angle iron 1812 is attached to the floor panel 1844 via fasteners 1814 (e.g., #10×1″ hex head self-drilling screws at 6″ OC into predrilled holes, factory installed). The upper utility wall 1842 also includes a base plate bracket 1808 to support an interior base plate 1810.

The floor panel 1844 includes a metal track 1816 (e.g., a 12″ 14 ga metal track that is coped at the ends, factory installed). First insulation 1820 (e.g., ½″×4″ semi-rigid mineral wool batt insulation, field finish installed) is installed where an end of the floor panel 1844 meets the upper utility wall 1842.

A third angle 1818 (e.g., 2″×2″×18 ga metal L angle) is attached to the floor panel bottom sheathing (e.g., via 1″ very high bond tape, field finish installed). A top panel of the interior of the lower utility wall 1846 attaches to the third angle 1818 via fasteners.

A sprinkler pipe 1822 is disposed between the interior sheathing and the top panel of the lower utility wall 1846. A hat channel 1824 and 1832 couples the finish panels of the lower utility wall 1846 to the sheathing and sheet metal layers of the lower utility wall 1846.

Second insulation 1826 (e.g., 2½″ semi-rigid mineral wool batt insulation) is field finish installed at the junction where the upper utility wall 1842 meets the lower utility wall 1846. A riser to riser connection 1828 is field finish installed to connect the waste and vent pipes 1848 and 1834 (e.g., 4″ pipe) factory installed within the utility walls 1842 and 1846, respectively. A fire caulk seal 1830 is factory installed at an opening where the waste/vent pipe 1834 exits the utility wall 1846 sheathing.

Also shown in FIG. 18 is a floor assembly 1836 (e.g., for a corridor walkway between units) including a 2-hour rated 3.25″ lightweight concrete over a 2″ metal pan deck. The floor assembly 1836 is supported by a corridor beam 1838 coupled to a structural column 1840.

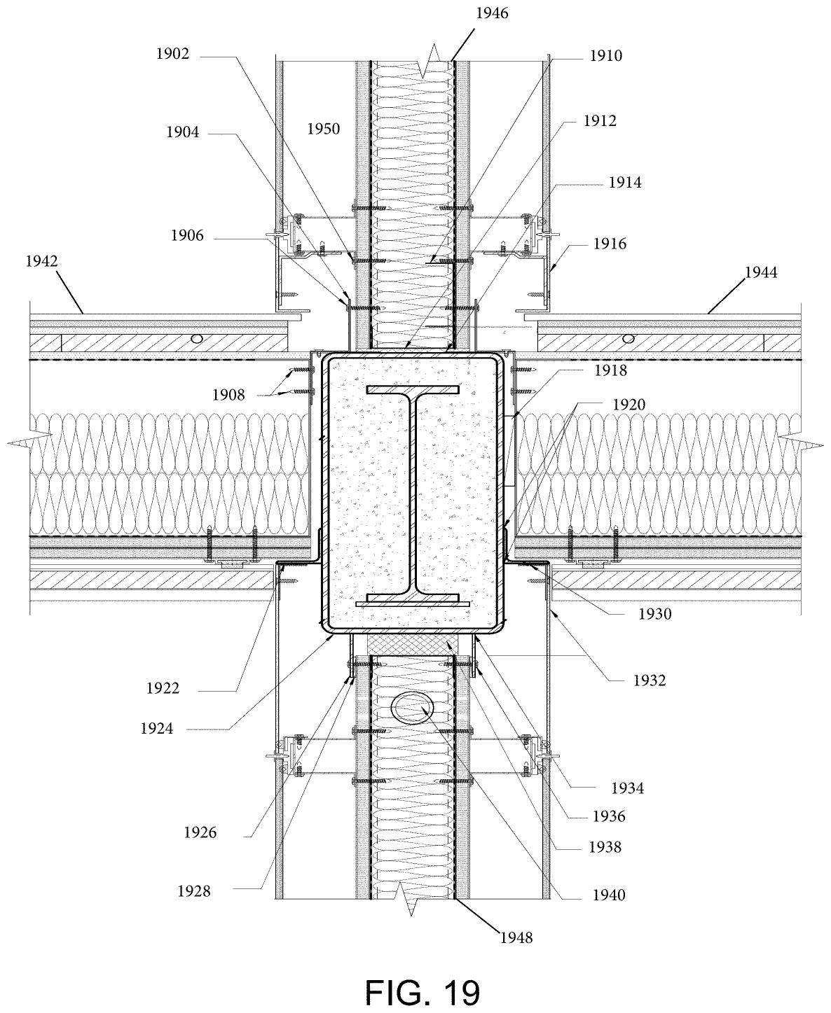

FIG. 19 is a cross sectional view of an example corbel beam at a floor panel and demising wall junction in accordance with some implementations. Specifically, FIG. 19 is a cross sectional view of an example corbel beam 1924 at a junction where a first floor panel 1942, a second floor panel 1944, a first demising wall 1946 and a second demising wall 1948 meet.

The first demising wall 1946 includes first fasteners 1902 (e.g., #8×1⅝″ wafer head drill point #2 Phillips at 24″ OC into sheet steel) attaching hat channels 1950 to the demising wall and extending through gypsum sheathing and sheet metal. On each side of the bottom of the first demising wall 1946, where the first demising wall 1946 meets the corbel beam 1924, an angle iron 1904 (e.g., a 1¾″×3″×14 ga attached to a 3″×3″×12 ga angle iron welded to the corbel beam 1924 at weld 1914) is installed (e.g., attached to the 3″×3″ angle iron using screws) and coupled to the first demising wall 1946 via fasteners 1906 (e.g., 8×1⅝″ wafer head drill point #2 Phillips at 24″OC into stud). The floor panels 1942 and 1944 are attached to angle iron coupled to the corbel beam 1924 using fasteners (e.g., 1908).

A c-channel metal track 1910 (e.g., a 3⅝″×8′ 18 ga metal track with knockouts at stud locations is factory installed. First insulation 1912 (e.g., 4″×¼″ ceramic fiber insulation) adhered to the bottom of the demising wall 1946 in the factory. The demising walls include a base plate 1916 (e.g., a 5 mm aluminum composite material base plate).

A spacer 1918 (e.g., a ½″×3″×4″ spacer) is factory installed on one side only of the corbel beam. Angle irons 1922 and 1930 are welded to the corbel beam 1924 (e.g., at welds 1920). A pair of plates 1926 are welded to each side of the bottom of the corbel beam 1924 (e.g., at welds 1934) to couple the second demising wall 1948 to the corbel beam 1924 via fasteners 1936. Second insulation 1938 is factory installed at the top of the second demising wall 1948. One or more shims 1928 can be used to align the demising wall 1948 for coupling to the corbel beam 1924. Also, near the top of the second demising wall 1948, a fire sprinkler pipe 1940 is factory installed. A closure 1932 is provided on each side of the demising wall 1948 at the top.

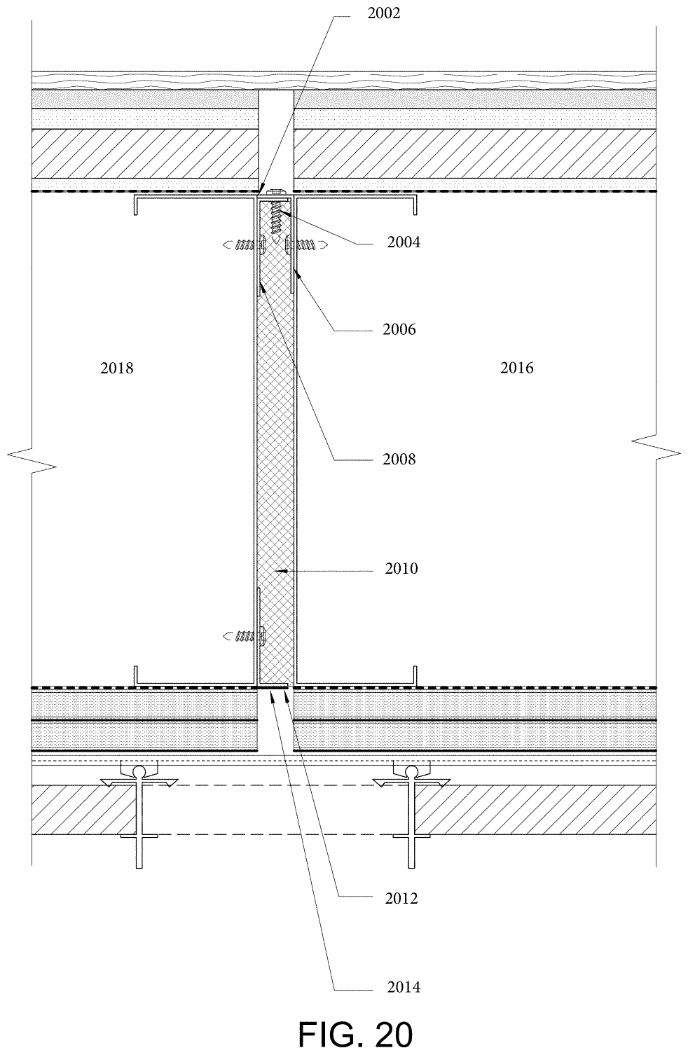

FIG. 20 is a cross sectional view of an example floor panel to floor panel connection in accordance with some implementations. In particular, FIG. 20 shows the connection 2002 where a middle floor panel 2016 (e.g., a floor panel that is not adjacent to a window wall or utility wall) abuts a window floor panel 2018. A first metal connection member 2006 is fastened to a second metal connection member 2008 via one or more fasteners 2004. The first and second connection members (2006 and 2008) can include 16 ga Fy=50 ksi bent CFS ¾″×2″ with pre-punched holes. Insulation 2010 (e.g., 1″ semi-rigid mineral wool insulation board compressed to ¾″ adhered to window floor panel, factory installed) is disposed within the space between the two floor panels 2016 and 2018. A metal angle 2012 is coupled to the window floor panel joist at the factory. Fire tape 2014 is factory installed.

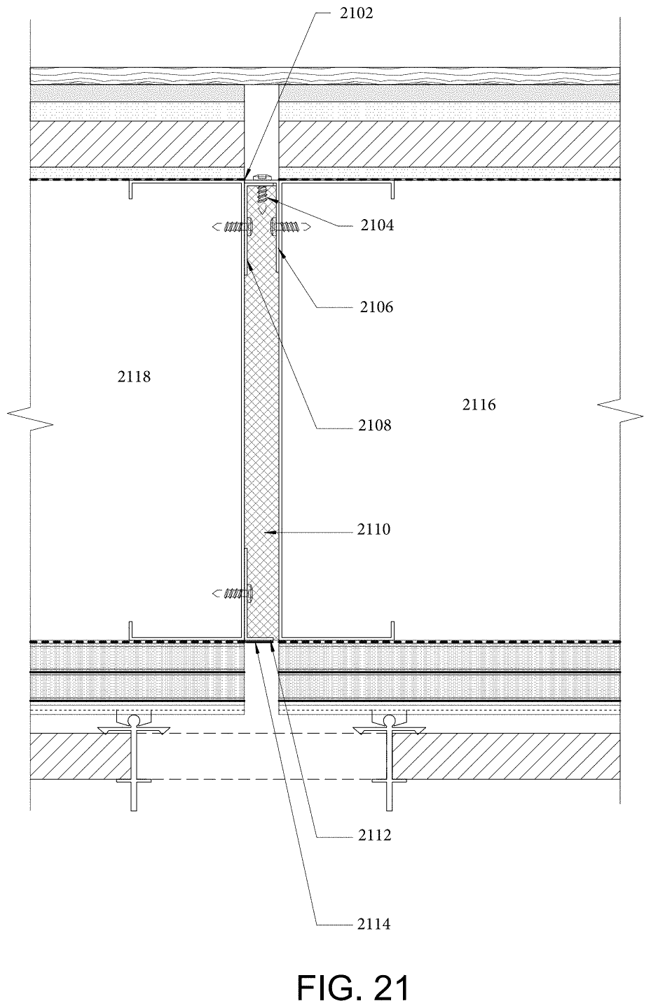

FIG. 21 is a cross sectional view of an example floor panel in accordance with some implementations. In particular, FIG. 21 shows the connection 2102 where a middle floor panel 2118 (e.g., a floor panel that is not adjacent to a window wall or utility wall) abuts a utility wall floor panel 2116. A first metal connection member 2106 is fastened to a second metal connection member 2108 via one or more fasteners 2104. The first and second connection members (2106 and 2108) can include 16 ga Fy=50 ksi bent CFS ¾″×2″ with pre-punched holes. Insulation 2110 (e.g., 1″ semi-rigid mineral wool insulation board compressed to ¾″ adhered to middle panel, factory installed) is disposed within the space between the two floor panels 2116 and 2118. A metal angle 2112 is coupled to the middle panel joist at the factory. Fire tape 2114 is factory installed.

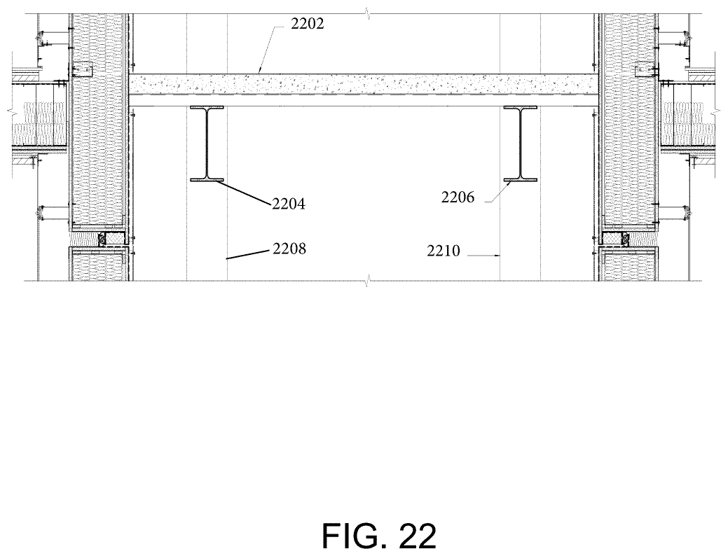

FIG. 22 is a cross sectional view of an example interior corridor in accordance with some implementations. In particular, FIG. 22 shows a corridor floor 2202 (e.g., 2-hr rated floor assembly including a 3.25″ lightweight concrete slab over a 2″ metal pan deck) supported by corridor beams 2204 and 2206 that are attached at each end to columns (e.g., 2208 and 2210, at one end).

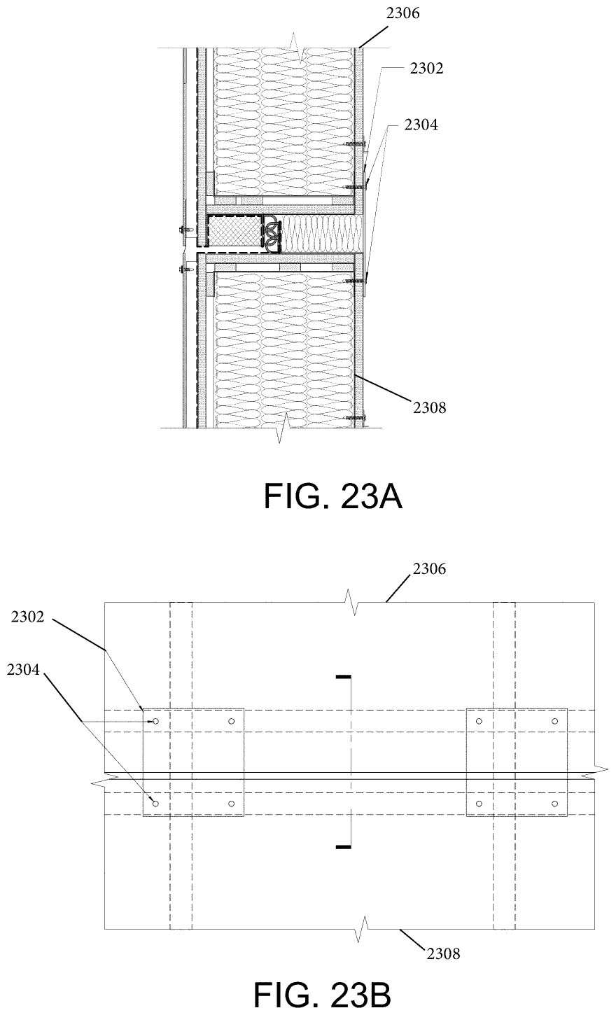

FIGS. 23A and 23B show example utility wall connections in accordance with some implementations. FIG. 23A is a section view of the connection between an upper utility wall 2306 and a lower utility wall 2308. One or more plates 2302 (e.g., an 8″×8″×18 ga plate every 24″ OC) are used to join the upper and lower utility walls 2306 and 2308. The plates 2302 are coupled to the utility walls (2306 and 2308) using fasteners 2304. FIG. 23B is an elevation view of the connection between the two utility wall panels (2306 and 2308).

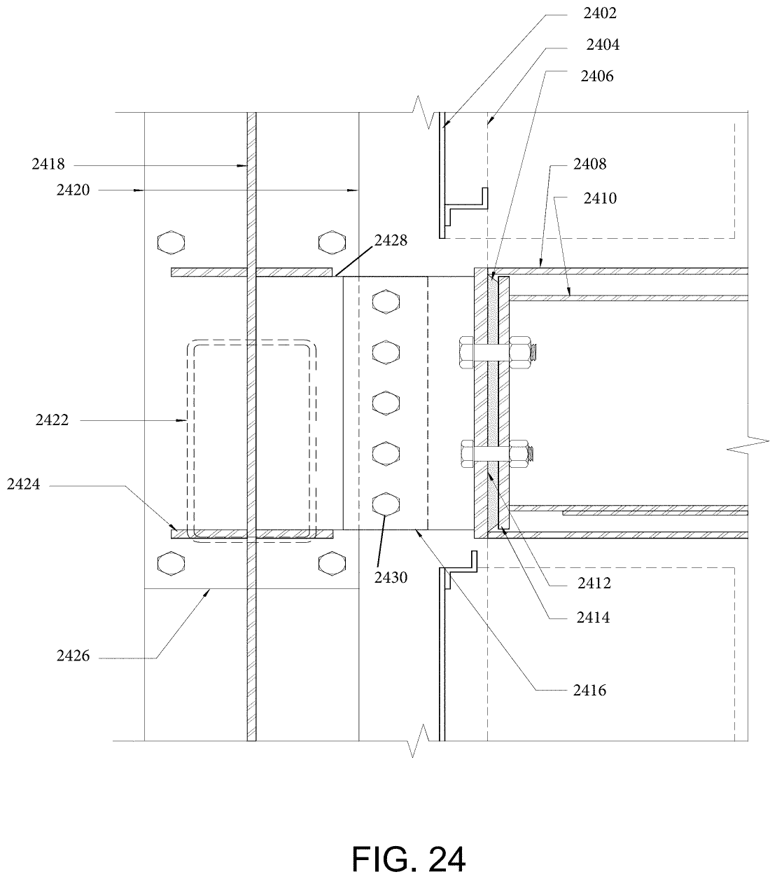

FIG. 24 shows an example corbel beam connection at a demising wall and end wall in accordance with some implementations. FIG. 24 shows a closure 2402 of a wall and a floor panel (edge shown at 2404) supported by a corbel beam 2408 (e.g., similar to 1722 of FIG. 17). The end of the corbel beam includes a cap plate 2414 (e.g., ½″ plate cut to inside radius of the HSS of the corbel beam 2408 and ⅛″ short on all sides, factory installed), insulating material 2406 (e.g., ½″ thermal insulating material, factory installed), and an end plate 2412 (e.g., ⅝″×8″×16″, factory installed), where the end plate 2412 is coupled (e.g., bolted) to the cap plate 2414 and to a connection plate 2416 (e.g., a ¾″×6⅛″×15″ plate with five 1″ diameter holes).

The connection plate 2416 is bolted to a shear tab 2428 using five one inch bolts 2430. The shear tab 2428 is coupled to a column flange 2420 and web 2418. Stiffeners 2424 are coupled to the column above and below the shear tab 2428. A plate 2426 is coupled to the column flange 2420 on each side where the shear tab 2428 is coupled to the column. A balcony beam 2422 is shown beyond the column.

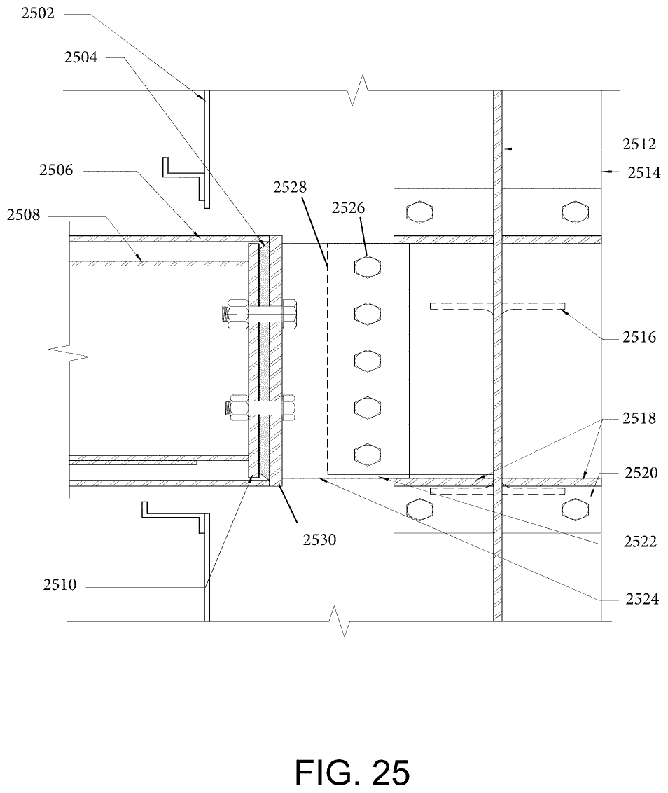

FIG. 25 shows an example corbel beam at a demising wall and utility wall in accordance with some implementations. FIG. 25 shows a closure 2502 of a wall supported by a corbel beam 2506 (e.g., similar to 1722 of FIG. 17). The end of the corbel beam 2506 includes a cap plate 2410 (e.g., a ½″ plate cut to inside radius of the HSS of the corbel beam 2506 and ⅛″ short on all sides, factory installed), insulating material 2504 (e.g., ½″ thermal insulating material, factory installed), and an end plate 2530 (e.g., ⅝″×8″×16″, factory installed), where the end plate 2530 is coupled (e.g., bolted) to the cap plate 2510 and to a connection plate 2524 (e.g., a ¾″×6⅛″×15″ plate with five 1″ diameter holes).

The connection plate 2524 is bolted to a shear tab 2528 using five one inch bolts 2526. The shear tab 2528 is coupled to a column flange 2514 and web 2512. Stiffeners 2518 are coupled to the column above and below the shear tab 2528. A plate 2520 is coupled to the column flange 2514 on each side where the shear tab 2528 is coupled to the column. A corridor beam 2516 is shown beyond the column.

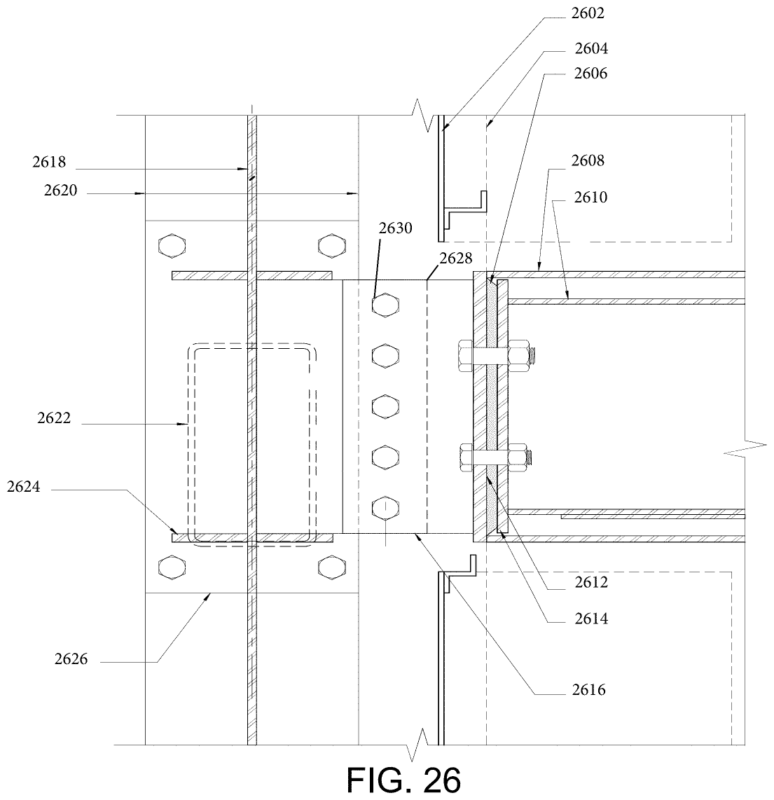

FIG. 26 shows an example corbel beam at an end wall and window wall in accordance with some implementations. FIG. 26 shows a closure 2602 of a wall and a floor panel (edge shown at 2604) supported by a corbel beam 2608 (e.g., similar to 1722 of FIG. 17). The end of the corbel beam includes a cap plate 2614 (e.g., a ½″ plate cut to inside radius of the HSS of the corbel beam 2608 and ⅛″ short on all sides, factory installed), insulating material 2606 (e.g., ½″ thermal insulating material, factory installed), and an end plate 2412 (e.g., ⅝″×8″×16″, factory installed), where the end plate 2612 is coupled (e.g., bolted) to the cap plate 2614 and to a connection plate 2616 (e.g., a ¾″×6⅛″×15″ plate with five 1″ diameter holes).

The connection plate 2616 is bolted to a shear tab 2628 using five one inch bolts 2630. The shear tab 2628 is coupled to a column flange 2620 and web 2618. Stiffeners 2624 are coupled to the column above and below the shear tab 2628. A plate 2626 is coupled to the column flange 2620 on each side where the shear tab 2628 is coupled to the column. A balcony beam 2622 is shown beyond the column.

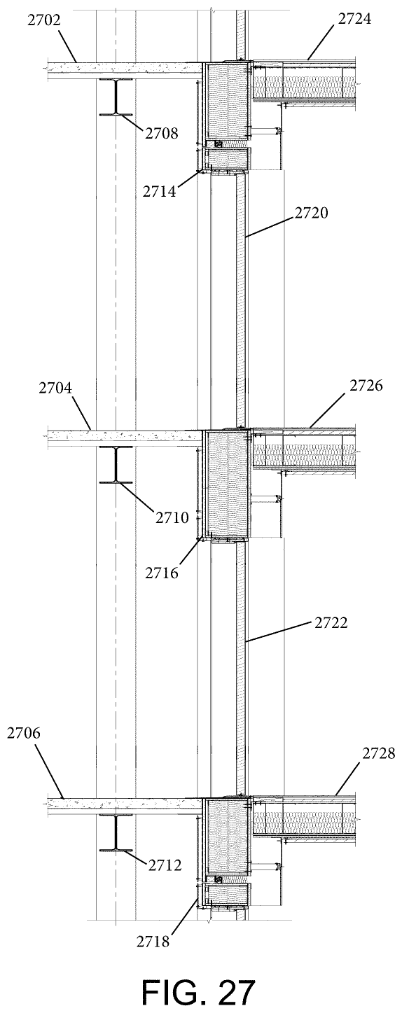

FIG. 27 shows an example entry door section at a utility wall in accordance with some implementations. In particular, FIG. 27 shows corridor floors (2702-2706) supported by corresponding corridor beams (2708-2712). Utility walls (2714-2718) are shown in connection with corresponding entry doors (2720-2722) that lead to units (e.g., an apartment unit, etc.). On an interior of each unit corresponding to an entry door is a floor panel (2724-2728).

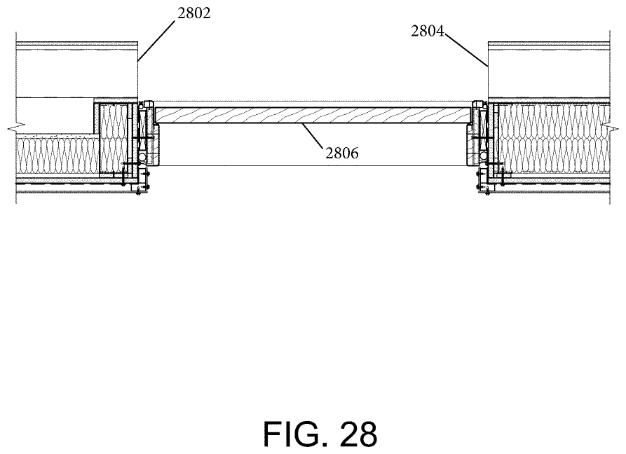

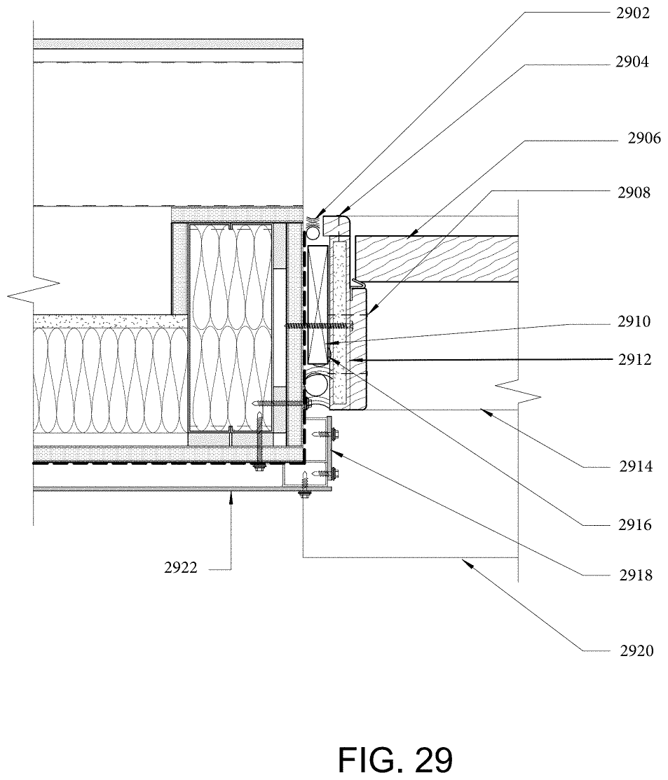

FIG. 28 shows a plan view of an example entry door at a utility wall in accordance with some implementations. In particular, FIG. 28 shows a first utility wall 2802 (e.g., similar to 600), a second utility wall 2804, and an entry door 2806. Details of the door jamb are shown in FIG. 29.

FIG. 29 shows details of an example entry door jamb in accordance with some implementations. In particular, FIG. 29 shows a door jamb 2912 (e.g., a rated door jamb anchored to the utility wall panel 2922 using #10 screws at 24″ OC, factory installed), including a solid wood applied stop 2908 (e.g., a solid wood stop attached in the factory using 1½″ finish nails at 12″ OC), and a shim 2910 (e.g., as necessary to ensure the door jamb fits tightly against the utility wall 2922). A door 2906 (e.g., a rated entry door) is shown meeting the stop 2908.

Trim 2904 can be attached in the field. A sealant and backer rod can be applied to an interior 2902 and an exterior 2916 gap where the door jamb assembly meets the utility wall 2922. The door threshold below is shown by line 2914. At the exterior corner of the utility wall 2922, exterior to the door jamb assembly, a closure panel 2918 (e.g., an aluminum composite material closure panel) is attached to the utility wall 2922 (e.g., using extruded aluminum vertical furring). A decorative steel plate 2920 can be field finish installed at the threshold.

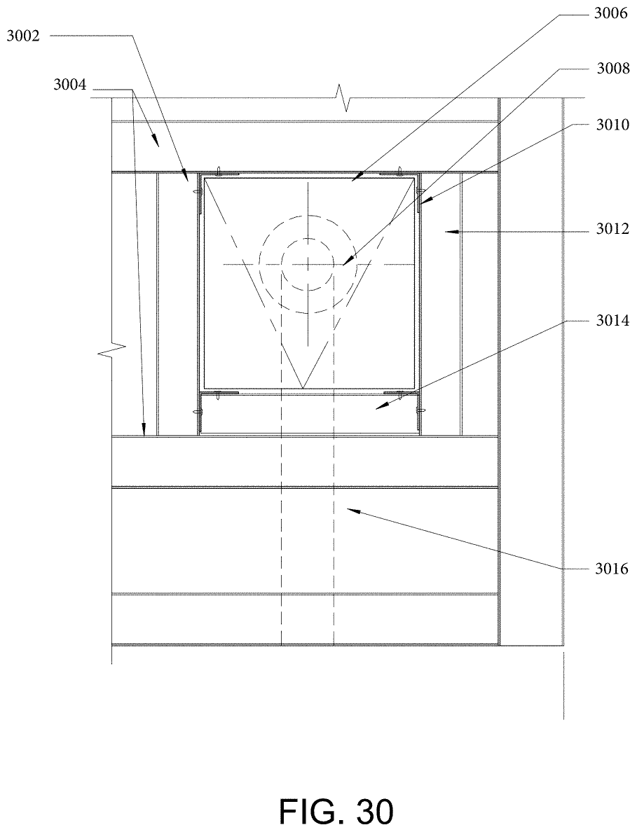

FIG. 30 shows an example ceiling access door blocking in accordance with some implementations. In particular, FIG. 30 shows 12″ metal joist blocking 3002 and 3012 spanning between metal floor joists 3004. The floor joists can have other spacing, such as 10″, and the blocking 3002 and 3012 would be sized accordingly. A ceiling access door 3006 (e.g., an 8″×8″ ceiling access door) is installed below a shower drain 3008, which is connected to a drain pipe 3016. The ceiling access door 3006 is installed within a frame formed by the blocking and joists that are connected at the corners by one or more clips 3010 (e.g., 1½″×7½″×20 ga fastened to the joists and blocking in the factory). A metal cover 3014 (e.g., 1½″×1½″×20 ga) can be attached to the joists and blocking via one or more clips (e.g., 1½″×1½″×20 ga clip angles attached via screws in the factory). The ceiling access door 3006 provides access to the shower drain area from a unit below the unit in which the shower is located.

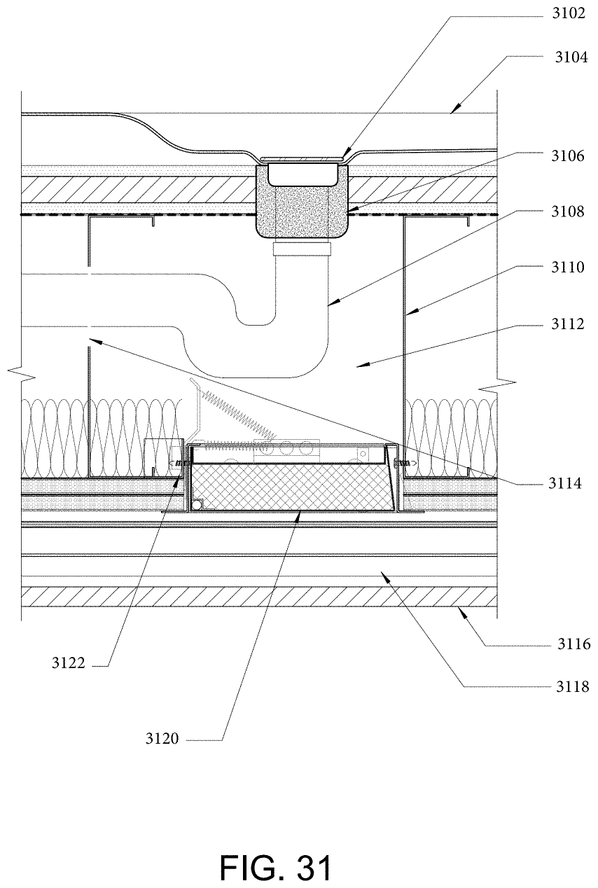

FIG. 31 shows an example shower drain and ceiling access door in accordance with some implementations. In particular, a shower drain 3102 (factory installed) is coupled to a shower pan 3104. A firestop 3106 (e.g., a 2-hr firestop) is installed at the pipe penetration through the floor. A drain pipe 3108 is coupled to the shower drain 3102 and leads to a utility wall. Steel joists (e.g., 3110) are installed in the floor panel (e.g., at 10″ or 12″ OC). An opening 3114 is cut into a joist to permit the drain pipe 3108 to pass through. A metal blocking 3112 (e.g., a 10″ wide metal blocking) and 3122 is installed for access door 3120 attachment. The access door 3120 can include a 90 minute rated access door fastened to joists 3110 and blocking 3112 and 3122 at the factory. A ceiling panel 3116 is field finish installed below the floor panel and a light rail 3118 is factory installed.

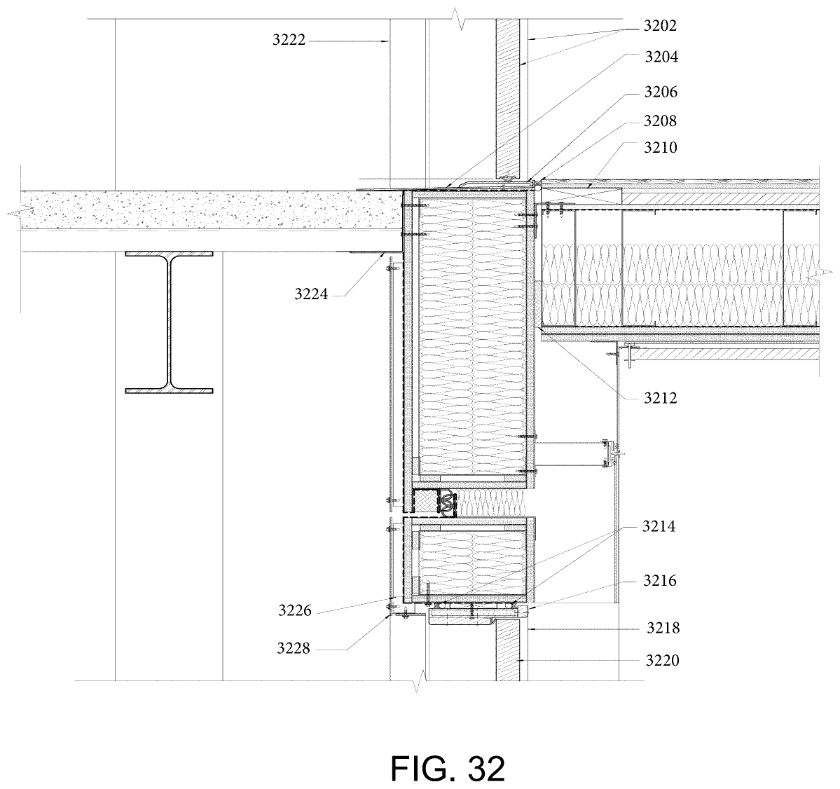

FIG. 32 shows an example utility wall at a unit entry door in accordance with some implementations. In particular, FIG. 32 shows a door and frame 3202. A decorative steel plate 3204 (e.g., a ⅛″ decorative steel plate set in a bed of sealant with a max slope of 2%, field finish installed). A metal door threshold 3206 is field finish installed above the decorative steel plate 3204. A sealant 3208 is applied to the joint between the floor panel and utility wall. A shim 3210 can be installed as required for flush install of finish floor. Insulation 3212 (e.g., ½″ semi-rigid mineral wool insulation adhered to the floor panel) is factory installed on the floor panel.

At a bottom of the utility wall, a top of an entry door jamb is shown. Sealant and backer rod 3214 is field finish installed at the junction where the top of the entry door jamb meets the bottom of the utility wall. A wood trim 3216 is field finish installed. A rated door jamb 3218 is anchored to the wall panel in field finish process. A rated door 3220 is shown.

A metal panel closure and vertical aluminum furring 3228 is installed on an exterior of the utility wall. A perforated insect screen 3226 is factory installed on the utility wall panel. An angle iron 3224 (e.g., a 5″×4″×16 ga L angle is attached to the utility wall at the floor opening and supports the end of the corridor floor. At the upper entry doorway, a closure panel 3222 (e.g., an aluminum composite material panel, factory installed) is installed.

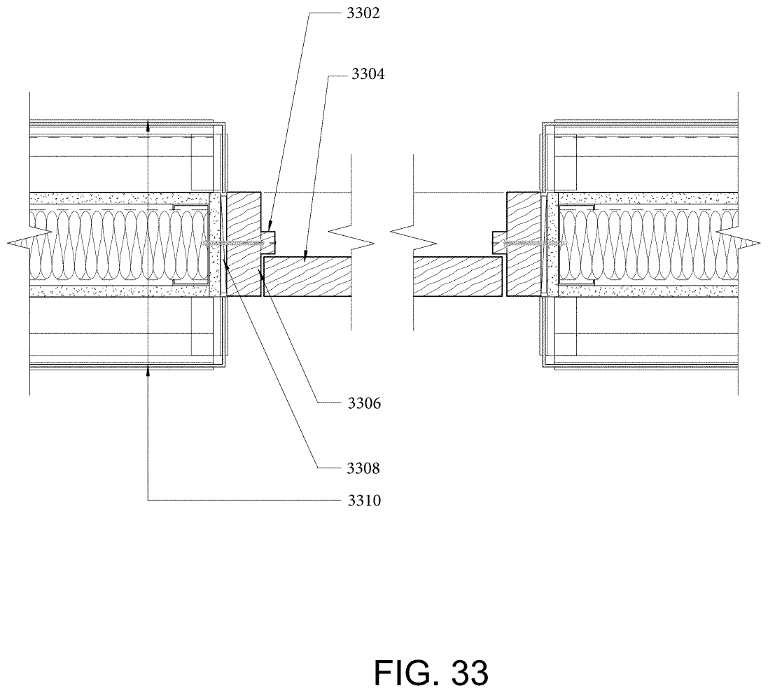

FIG. 33 shows an example bedroom wall door jamb in accordance with some implementations. In particular, the bedroom wall door jamb includes a solid wood door 3304, a solid wood stop 3302 attached to a wood jamb 3306, a shim 3308 (as required), and a bedroom wall 3310.

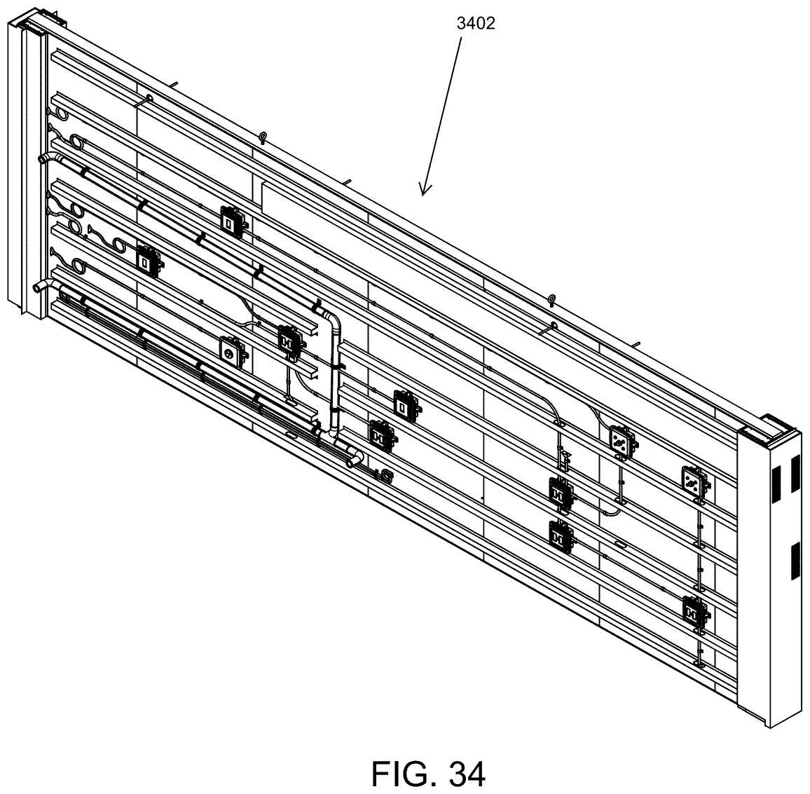

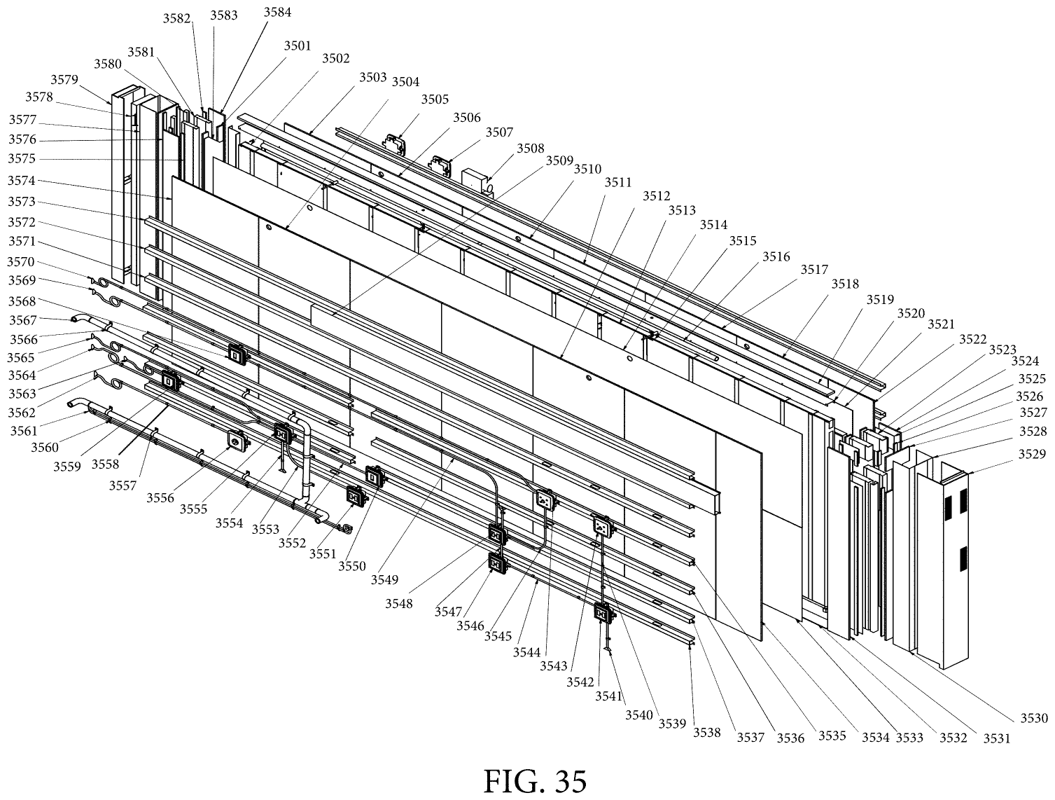

FIG. 34 shows a cut away view of an example demising wall 3402 in accordance with some implementations. FIG. 35 shows an exploded view of the components and arrangement of the components of the example demising wall 3402 of FIG. 34 in accordance with some implementations. The demising wall 3402 includes glassmat sheathing board 3501, semi-rigid mineral wool batt insulation 3502, glassmat sheathing board 3503, glassmat sheathing board 3504, a wall box light 3505, glassmat sheathing board 3506, and wall box light 3507. The utility wall 3402 also includes a ventilation fan housing 3508, a microwave exhaust duct 3509, glassmat sheathing board 3510-3512 , semi-rigid mineral wool batt insulation 3513, sheet steel 3514, bent plate 3515, sprinkler pipe 3516, glassmat sheathing board 3517-3518, semi-rigid mineral wool insulation board 3519, a track 3520, sheet steel 3521, glassmat sheathing board 3522, semi-rigid mineral wool batt insulation 3523, glassmat sheathing board 3524, sheet steel 3525, and thermal insulating material 3526.

The demising wall 3402 further includes glassmat sheathing board 3527, a weather resistive barrier 3528, a demising wall cover 3529, a weather resistive barrier 3530, glassmat sheathing board 3531, ceramic fiber insulation 3532, sheet steel 3533, glassmat sheathing board 3534, hat channel 3535-3538, armored cable 3539-3540, quad outlet wall box 3541, shade driver wall box 3542, low voltage wall box 3543, armored cable 3544, CAT6 jumper 3545, quad outlet wall box 3546, armored cable 3547, duplex wall box 3548, armored cable 3549, duplex wall box 3550, and a dishwasher outlet wall box 3551. The utility wall 3402 further includes armored cable 3552-3554, a duplex wall box with outlets and disposal switch 3555, a range wall box 3556, a pipe strap 3557, a conduit strap 3558, a duplex wall box 3559, a pipe strap 3560, pex pipe 3561, armored range cable 3562, armored cable 3563, armored cable 3564-3565, a pipe strap 3566, and a plumbing sub-assembly 3567 (e.g., sink drain and vent).

The demising wall 3402 further includes a duplex wall box 3568, armored cable 3569, low voltage wiring 3570, hat channel 3571-3573, glassmat sheathing board 3574, thermal insulating material 3575, glassmat sheathing board 3576, weather resistive barrier 3577, semi-rigid mineral wool batt insulation 3578, demising wall cover 3579, stud 3580, semi-rigid mineral wool batt insulation 3581, thermal insulating material 3582, gasket zee clip 3583, and glassmat sheathing board 3584.

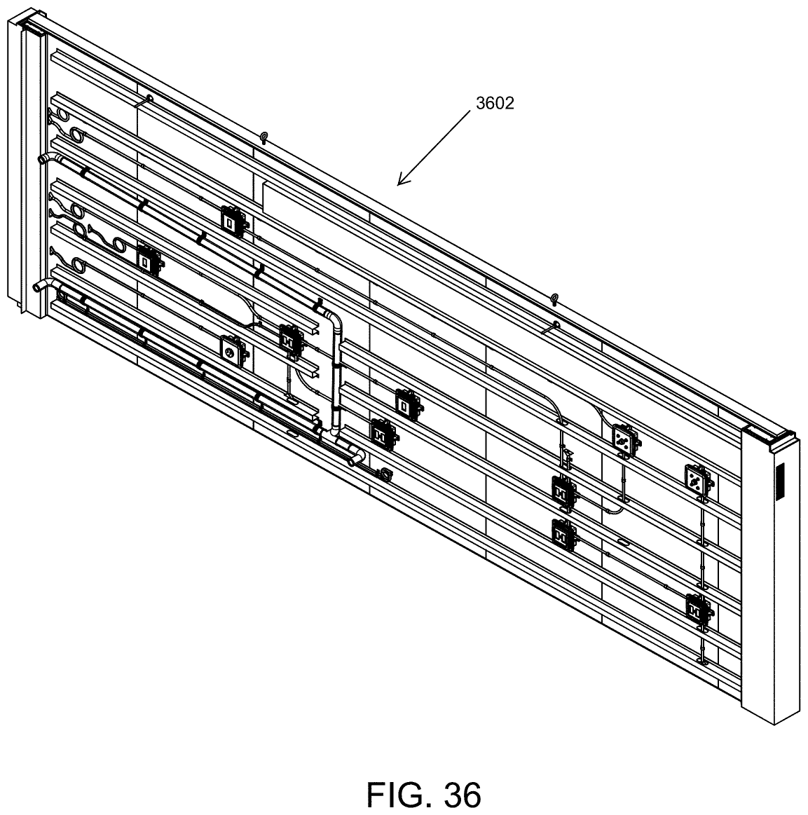

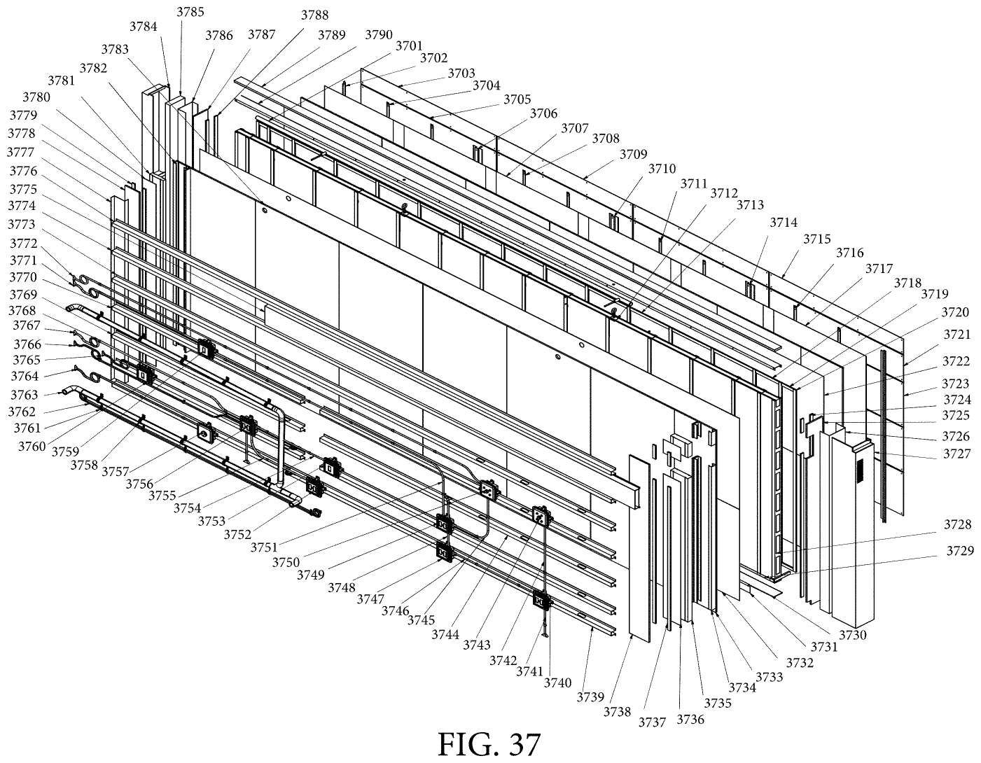

FIG. 36 shows a cut away view of an example end wall 3602 in accordance with some implementations. FIG. 37 shows an exploded view of the example end wall 3602 of FIG. 36 in accordance with some implementations. The end wall 3602 includes a sprinkler pipe 3701, an end wall edge flashing 3702, an ACM panel 3703, vertical aluminum furring 3704, an ACM panel 3705, vertical aluminum furring 3706, a weather resistive barrier 3707, a vertical aluminum furring 3708, ACM panel 3709, vertical aluminum furring 3710-3711, bent plate 3712, thermal insulating material 3713, vertical aluminum furring 3714, ACM panel 3715, vertical aluminum furring 3716, weather resistive barrier 3717, and thermal insulating material 3718-3719.

The end wall 3602 also includes thermal insulating material 3720, ACM panel 3721, sheet steel 3722, ACM panel 3723, thermal insulating material 3724, glassmat sheathing board 3725, weather resistive barrier 3726, end wall cover 3727, R-stud 3728, track 3729, ceramic fiber insulation 3730, track 3731, sheet steel 3732, stud 3734, semi-rigid mineral wool batt insulation 3735, sheet steel 3736, thermal insulating material 3737, glassmat sheathing board 3738, hat channel 3739, a quad outlet wall box 3740, an armored cable 3741-3742, a shade driver wall box 3743, hat channel 3744, CAT6 jumper 3745, armored cable 3746, quad outlet wall box 3747, armored cable 3748, a duplex wall box with data 3749, low voltage wall box 3750, armored cable 3751, dishwasher quad wall box 3752, and a duplex wall box 3753.

The end wall 3602 further includes armored cable 3754, armored cable 3755, a duplex/disposal switch wall box 3756, a range duplex wall box 3757, a pipe strap 3758, a duplex wall box 3759, a duplex wall box 3760, a pipe strap 3761, pex pipe 3762, plumbing sub-assembly 3763 (e.g., sink drain and vent, cast iron), armored cable 3764-3767, conduit strap 3768, hat channel 3769-3770, armored cable 3771, low voltage cable 3772, hat channel 3773-3774, microwave exhaust duct 3775, hat channel 3776, gasket zee clip 3777, glassmat sheathing board 3778, thermal insulating material 3779, sheet steel 3780, semi-rigid mineral wool insulation 3781, stud 3782, glassmat sheathing board 3783, end wall cover 3784, semi-rigid mineral wool batt insulation 3785, weather resistive barrier 3786, glassmat sheathing board 3787, thermal insulating material 3788, semi-rigid mineral wool insulation board, 3789, and a track 3790.

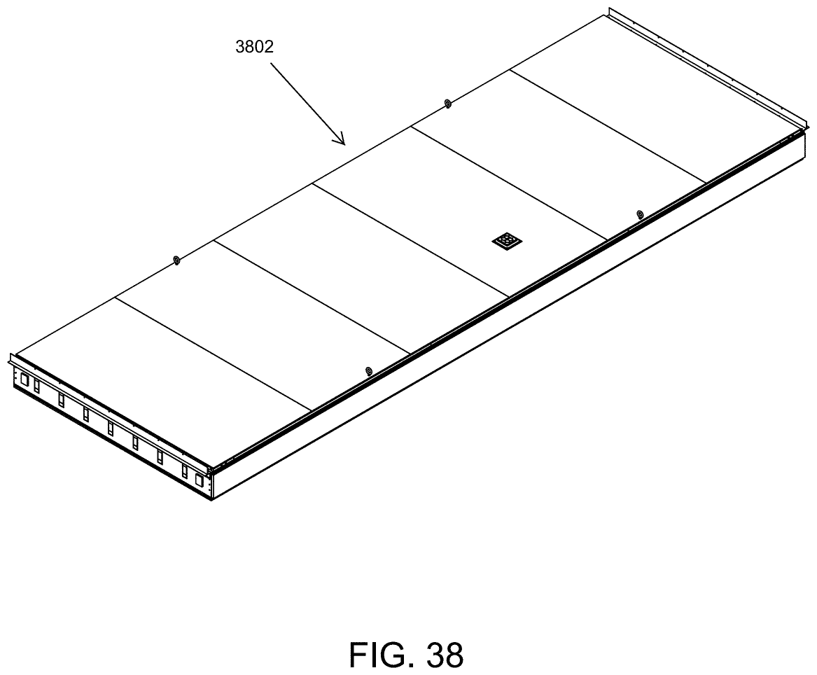

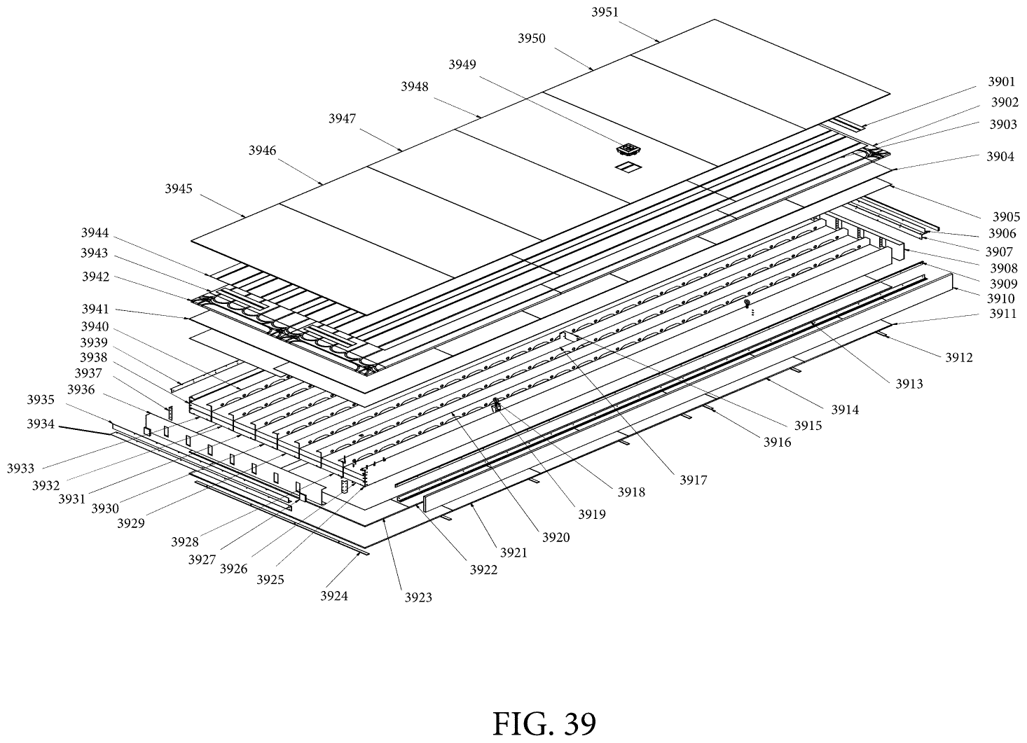

FIG. 38 shows an isometric view of an example middle floor panel 3802 in accordance with some implementations. FIG. 39 shows an exploded view of the example middle floor panel 3802 of FIG. 38 in accordance with some implementations. In particular, the middle floor panel 3802 includes a hydronic aluminum plate 3901-3903, hydronic foam 3902 and 3942, cement board 3904, sheet steel 3905, angle iron 3906-3907, a track 3908, bent metal member 3909, semi-rigid mineral wool insulation 3910, glassmat sheathing board 3911, FRP light clip 3912, sheet steel 3913, glassmat sheathing board 3914, blocking 3915, FRP light clip 3916, and angle iron 3917.

The middle floor panel 3802 also includes eyebolts 3918-3919, joist 3920, glassmat sheathing board 3921-3923, FRP light clip 3924, screws 3925, semi-rigid mineral wool batt insulation 3926, glassmat sheathing board 3927, semi-rigid mineral wool batt insulation 3928-3933, angle iron 3934-3935, track 3936, angle iron 3937, joist 3938, bent metal 3939, joist 3940, cement board 3941, hydronic foam 3942-3943, hydronic aluminum plate 3944, cement board 3945-3948, quad outlet floor box 3949, and cement board 3950-3951.

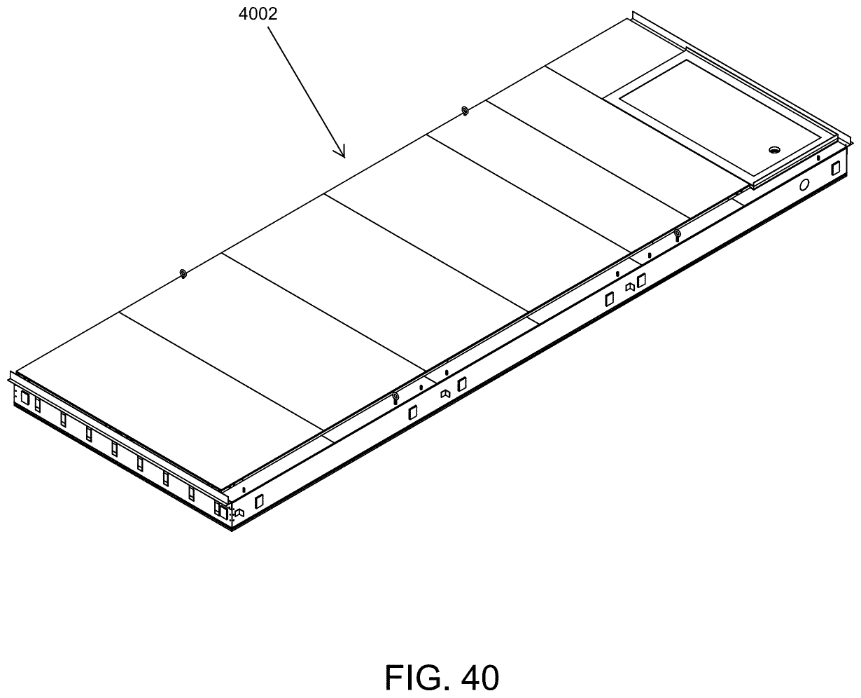

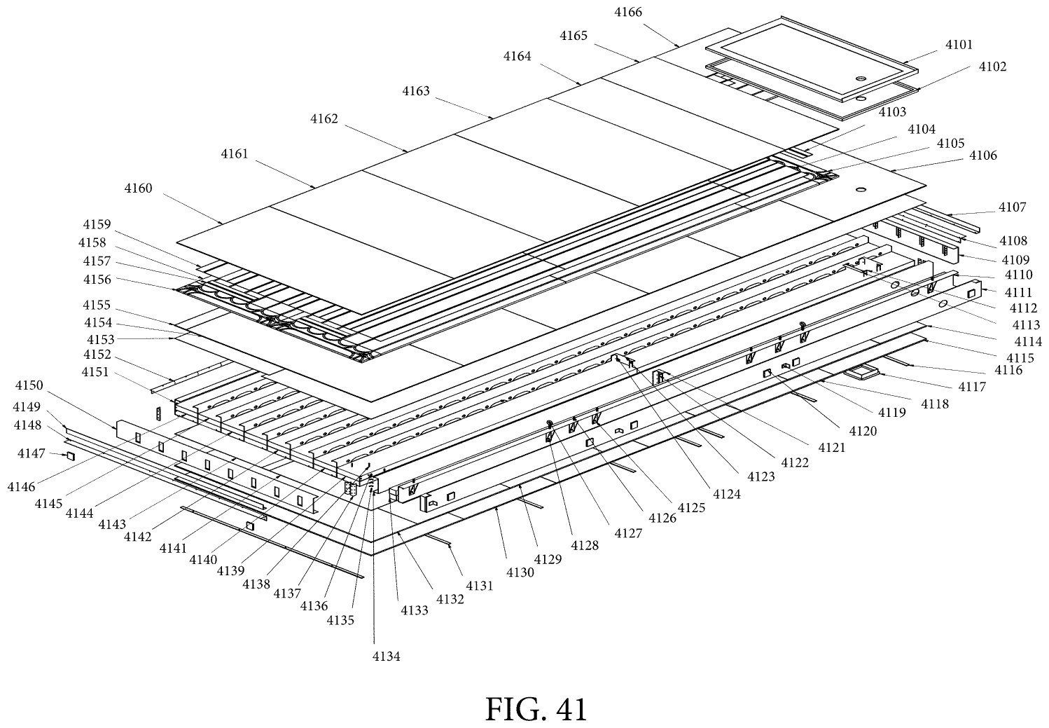

FIG. 40 shows an isometric view of an example bathroom floor panel 4002 in accordance with some implementations. FIG. 41 shows an exploded view of the example utility wall floor 4002 panel of FIG. 40 in accordance with some implementations. The floor panel 4002 includes a shower pan 4101, a shower base support 4102, hydronic aluminum plate 4103-4104, hydronic foam 4105, cement board 4106, angle iron 4107-4108, track 4109, joist 4110, track 4111, angle iron 4112, blocking 4113, glassmat sheathing board 4114-4115, FRP light clip 4116, access door 4117, glassmat sheathing board 4118, angle iron 4119, and glassmat sheathing board 4120.

The bathroom floor panel 4002 also includes blocking 4121, angle iron 4122, blocking 4123, angle iron 4124, hold down anchor 4125, threaded rod 4126, eyebolt 4127, hold down anchor 4128, glassmat sheathing board 4130, FRP light clip 4131, glassmat sheathing board 4132, semi-rigid wool batt insulation 4133, joist 4134, screws 4135-4136, angle iron 4137, screws 4138, semi-rigid mineral wool batt insulation 4139-4140, sheet steel 4141, and semi-rigid mineral wool batt insulation 4142.

The floor panel 4002 further includes sheet steel 4143, semi-rigid mineral wool batt insulation 4144-4146, glassmat sheathing board 4147, angle iron 4148-4149, track 4150, joist 4151, bent metal 4152, sheet steel 4153, cement board 4154-4155, hydronic foam 4156-4158, hydronic aluminum plate 4159, and cement board 4160-4166.

In some implementations, the walls described herein (e.g., utility, demising, etc.) can include vertical studs within an interior thermal envelope, where the vertical studs and thermal envelope are encased with an acoustic/fire barrier. Hat channel members are attached to the outer surfaces of the thermal envelop and provide space for horizontal distribution of pipes and modular electrical components. Within the two story wall panels (e.g., utility wall panels) vertical pipes run in vertical chase section to connect between floors. By providing vertical utility runs (e.g., pipes, etc.) within the two story wall panels, the number of connection compared to single story connection is reduced by half

Also, by encasing the vertical studs and thermal envelope within the acoustic/fire barrier and moving the utilities to the space between the acoustic/fire barrier and the finish system, a need to put holes into the acoustic/fire barrier is reduced or eliminated, which can improve acoustic performance characteristics. Also, because the finish system may include a finish system that is removable without tools, inspection and repair of any utilities running in the wall in the space provided by the hat channels is made significantly easier compared to conventional construction systems.

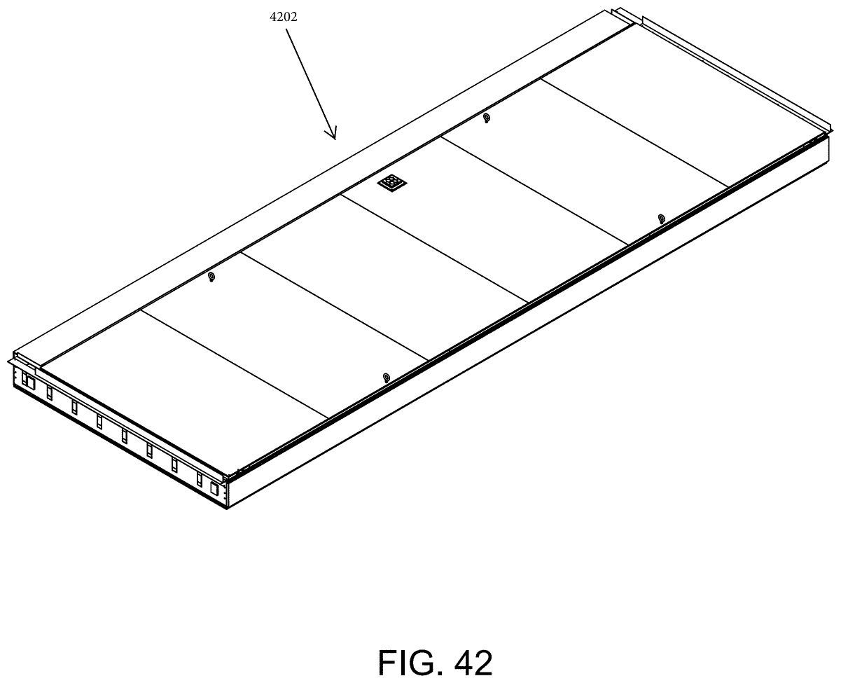

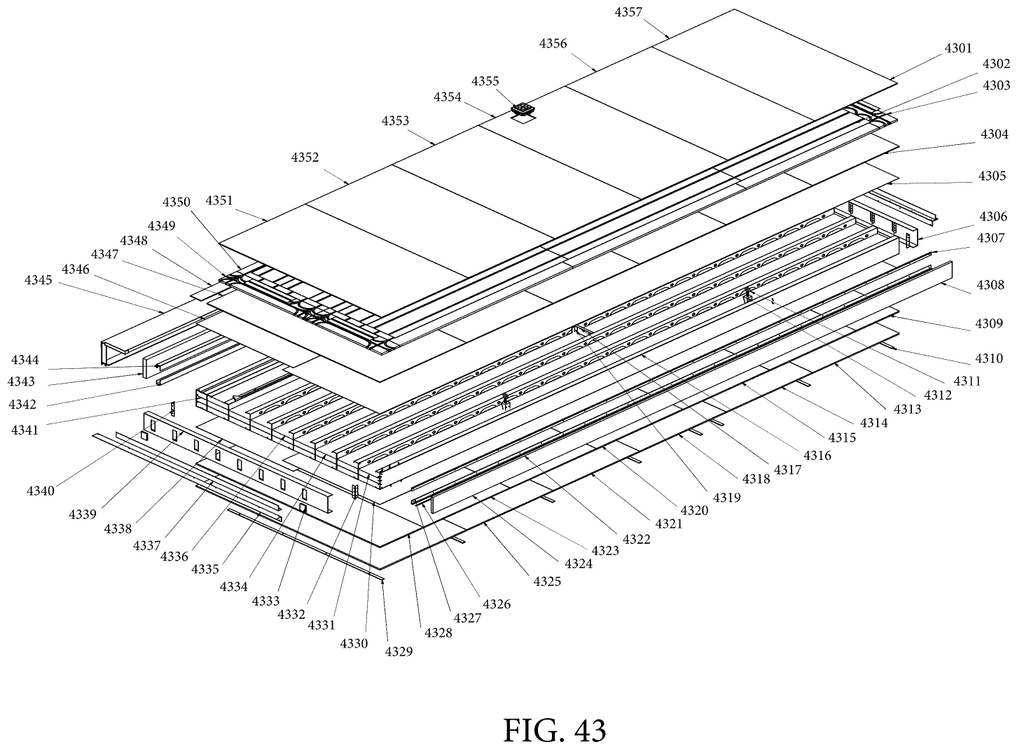

FIG. 42 shows an isometric view of an example window wall floor panel 4202 in accordance with some implementations. FIG. 43 shows an exploded view of the example window wall floor panel 4202 of FIG. 42 in accordance with some implementations. The window wall floor panel 4202 includes cement board 4301, hydronic aluminum plate 4302, hydronic foam 4303, cement board 4304, sheet steel 4305, track 4306, bent metal 4307, semi-rigid mineral wool batt insulation 4308, glassmat sheathing board 4309, FRP light clip 4310, eyebolt 4311, hold down anchor 4312, glassmat sheathing board 4313-4315, joist 4316, blocking 4317, glassmat sheathing board 4318, angle iron 4319, glassmat sheathing board 4320-4321, semi-rigid mineral wool insulation 4322, glassmat sheathing board 4323, semi-rigid mineral wool insulation 4324, glassmat sheathing board 4325, fire tape 4326, bent metal 4327, glassmat sheathing board 4328, FRP light clip 4329, sheet steel 4330, semi-rigid mineral wool batt insulation 4331, angle iron 4332, glassmat sheathing board 4333, semi-rigid mineral wool batt insulation 4334, angle iron 4335, semi-rigid mineral wool batt insulation 4336, angle iron 4337, and sheet steel 4338.

The window wall floor panel 4202 also includes track 4339, angle iron 4340, J channel 4342, semi-rigid mineral wool insulation board 4343, J channel 4344, floor cover 4345, sheet steel 4346, cement board 4347-4348, hydronic foam 4349-4350, cement board 4351-4354, quad outlet floor box 4355, cement board 4356-4357.

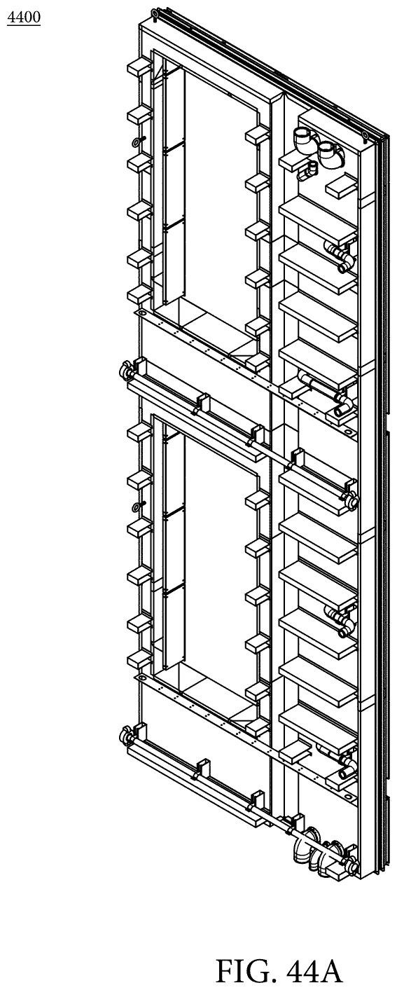

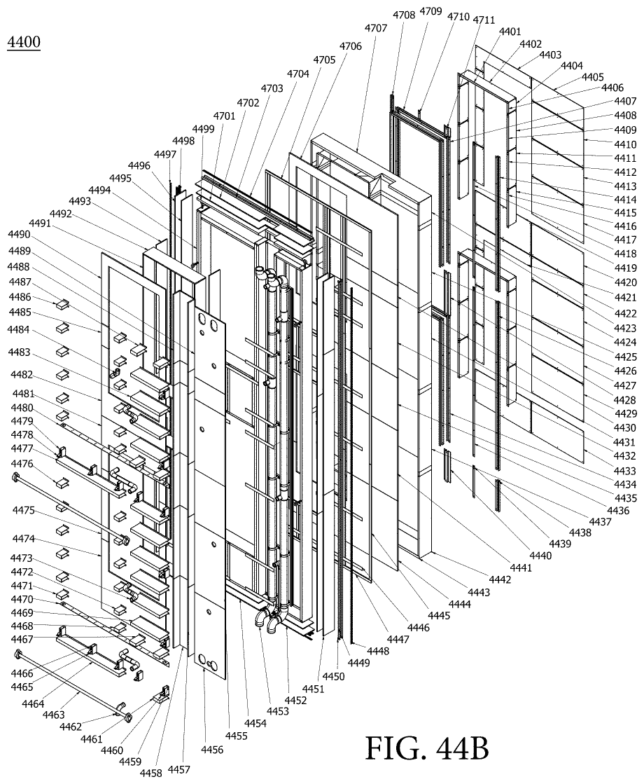

FIG. 44A shows an isometric view of an example door utility wall panel 4400 in accordance with some implementations. The door utility wall panel shown in FIG. 44A spans two floors of a multi-story building, but could be constructed to span more or less floors of a multi-story building. FIG. 44B shows an exploded view of the example door utility wall panel of FIG. 44A in accordance with some implementations.

The door utility wall panel 4400 includes a plurality of aluminum composite material panels 4401-4406, 4408-4413, 4415-4417, 4419-4422, 4424 4427, 4429, 4433, 4435, and 4481. The door utility wall panel 4400 also includes a plurality of glassmat sheathing boards 4407, 4423, 4430, 4432, 4452, 4454, 4702, 4496, 4451, 4492, 4491, 4444, 4441, 4475, 4485, 4706, 4474, 4482, 4490, 4457, 4488, 4456, 4455, and 4489. The door utility wall panel 4400 further includes aluminum vertical furring 4414, 4418, 4426, 4428, 4436, 4438, 4439, 4440, 4711, 4710, and 4709. The door utility wall panel 4400 also includes weather resistive barrier top 4425 and 4707, and weather resistive barrier 4431, 4434, 4437, and 4443. The door utility wall panel 4400 further includes gasket elbows 4450, aluminum termination bar 4448, gasket 4703, aluminum termination bar 4704, gaskets 4449 and 4498, and unistrut clamps 4460, 4465, and 4478. The door utility wall panel 4400 also includes hat channel members 4468, 4471, 4472, 4476, 4469, 4483, 4464, 4477, 4461, 4467, and 4487.

The door utility wall panel 4400 also includes flat stock 4446, angle metal 4470 and 4480, metal flashing 4442, unistrut 4459, 4466, and 4479. The door utility wall panel 4400 further includes thermal insulating material 4447, 4705, 4701, 4495, 4445, and 4493. The door utility wall panel 4400 also includes pipe sprinkler 4463, plumbing riser 4453, plumbing horizontal assembly 4462, 4473, and 4484, stud 4494, and track 4499.

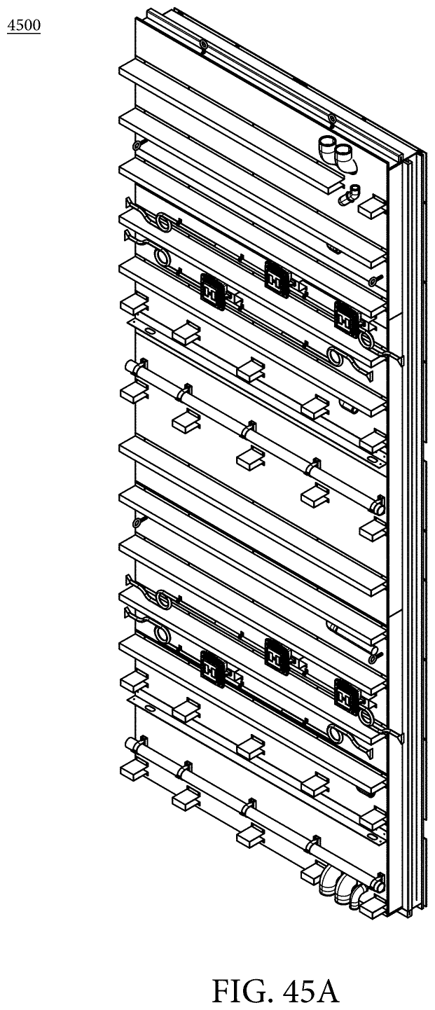

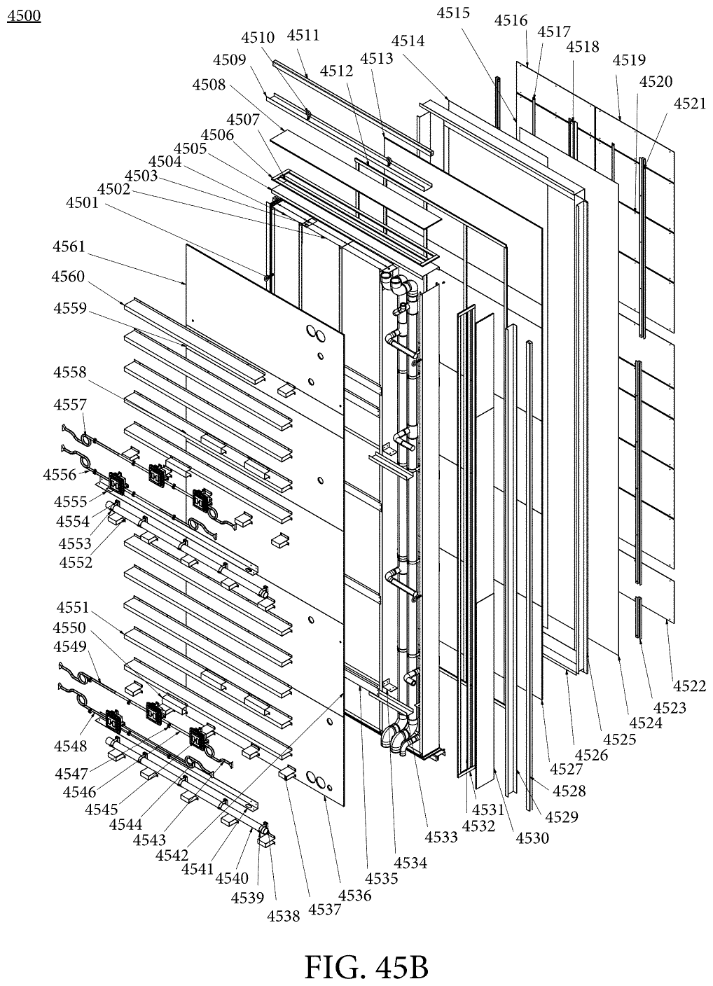

FIG. 45A shows an isometric view of an example kitchen utility wall panel 4500 in accordance with some implementations. The kitchen utility wall panel shown in FIG. 45A spans two floors of a multi-story building, but could be constructed to span more or less floors of a multi-story building. FIG. 45B shows an exploded view of the example kitchen utility wall panel 4500 of FIG. 45A showing parts and assembly in accordance with some implementations. The kitchen utility wall 4500 includes metals studs 4501 (e.g., six studs), semi-rigid mineral wool insulation 4502, bent metal plates 4503 (e.g., 3 in.×10 in.×6 in.×0.25 steel with predrilled holes), semi-rigid mineral wool insulation 4504, track piece 4505, thermal insulating material 4506 and 4507 (e.g., thermal insulating material with self adhered backing), glassmat sheathing board 4508, metal stock 4509, eyebolts 4510, gasket 4511, thermal insulating material 4512 (e.g., thermal insulating material with self adhered backing), and glassmat sheathing board 4513.

The kitchen utility wall 4500 also includes weather resistive barrier 4514 (e.g., VaproShield RevealFlashing SA or equivalent), aluminum composite material panels 4515 and 4516, aluminum vertical furring 4517 and 4518, aluminum composite material panels 4519 and 4520, and aluminum vertical furring 4521. The kitchen utility wall 4500 further includes aluminum composite material panels 4522, aluminum vertical furring 4523, weather resistive barrier 4524, 4525, and 4526 (e.g., VaproShield RevealFlashing SA or equivalent), glassmat sheathing board 4527, gaskets 4528, metal stock 4529, glassmat sheathing board 4530, and thermal insulating material 4531 and 4532 (e.g., thermal insulating material with self adhered backing).

The kitchen utility wall 4500 also includes blocking members 4533, angle members 4534 (e.g., 2.5×3.75×5 in.×16 GA steel angle pieces), angle members 4535 (e.g., 4×1×93.75 in.×18 GA steel angle pieces), glassmat sheathing board 4536, hat channel 4537, unistruts 4538 and 4539, pipe sprinkler 4540, and metal angle 4541 and 4555 (e.g., 3×3×94 in.×12 GA steel angle pieces), glassmat sheathing board 4542. The kitchen utility wall 4500 further includes modular electrical components 4543-4546, conduit strap 4547, modular electrical components 4548 -4549, hat channel 4550 and 4551, pipe sprinkler 4552, unistruts 4553 and 4554, and electrical components 4556-4557.

The kitchen utility wall 4500 also includes glassmat sheathing board 4558 and 4559, 4560 (MM.185), and glassmat sheathing board 4561.

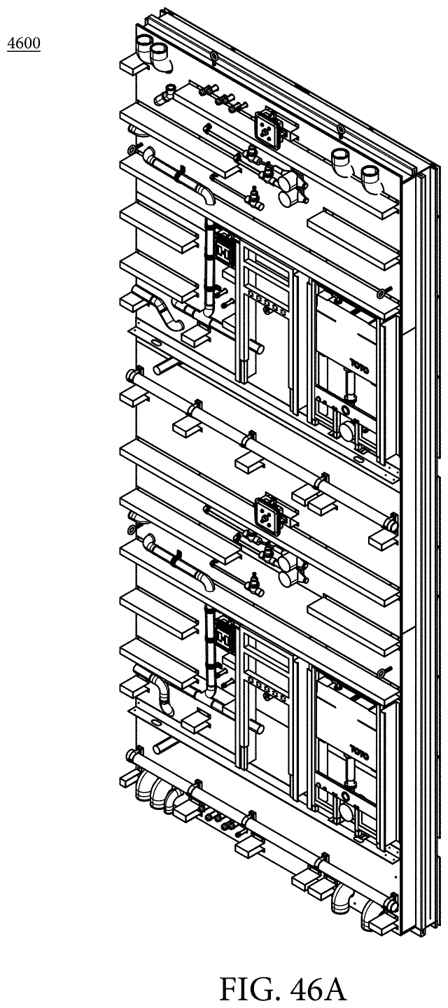

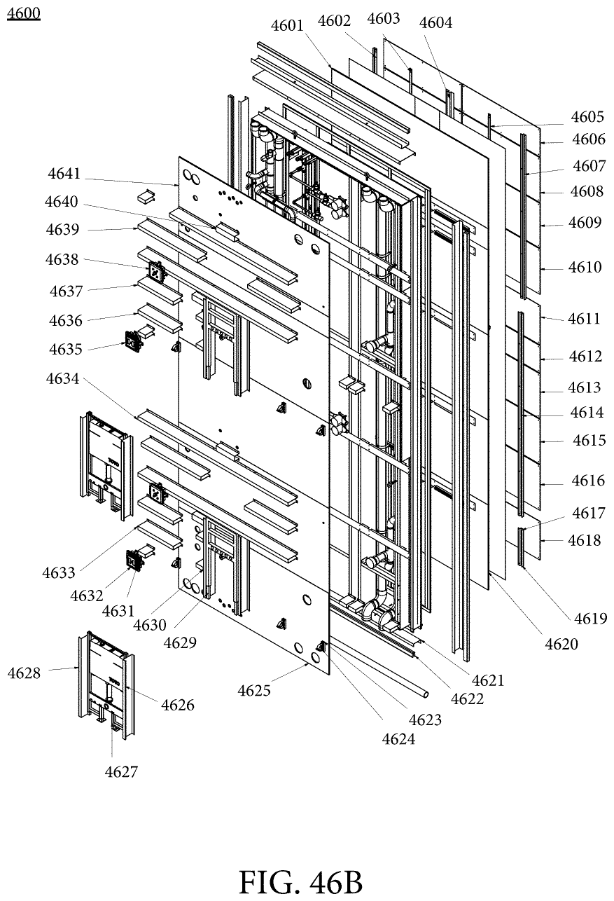

FIG. 46A shows an isometric view of an example bathroom utility wall panel 4600 in accordance with some implementations. The bathroom utility wall panel shown in FIG. 46A spans two floors of a multi-story building, but could be constructed to span more or less floors of a multi-story building. FIG. 46B shows an exploded view of the example bathroom utility wall panel 4600 of FIG. 46A in accordance with some implementations. The bathroom utility wall panel 4600 includes glassmat sheathing board 4601, and aluminum vertical furring (4602, 4603, 4604, 4605, 4607, 4614, 4617, and 4619). The bathroom utility wall panel 4600 also includes aluminum composite material panels (4606, 4608, 4609, 4610, 4611, 4612, 4613, 4615, and 4618), and glassmat sheathing board 4620.

The bathroom utility wall panel 4600 also includes metal stock 4621, gasket bottom 4622, unistruts 4623 and 4624, glassmat sheathing board 4625, track 4626, water closet in wall tank 4627, track 4628-4630, hat channels 4631-4632, and hat channels (4633, 4636, and 4637). The bathroom utility wall panel 4600 further includes hat channels 4634 and 4640, glassmat sheathing board 4641, boards 4635-4638, and metal stock 4639.

In some of the figures described above, a bottom of an upper component such as a wall is shown, and a top of a lower component of the same type is shown (e.g., where an upper wall and a lower wall meet at a corbel beam or otherwise). Each component of that type may include the features shown and described for both the bottom and top of the component.

The manufactured wall, ceiling and floor panels may be attached to the frame of a building, for example to a demising wall, ceiling/floor panel, or an internal or external structural frame. For example, the manufactured interior wall finish system and the manufactured ceiling finish system may be attached to one or more demising walls and/or floor panels within a building. Generally, any mechanism may be used to attach the wall, ceiling and floor panels to the building. Any type of fastener may generally be used.

One or more components of the wall, ceiling and floor panels described herein may be fabricated off-site in a factory or manufacturing facility and transported to the project jobsite for installation in a building. The manufactured wall, ceiling and floor panels and/or components thereof may be fabricated in various sizes. At the building site, the wall, ceiling and floor panels may be attached to structural frame members, floor and ceiling panels, end walls, demising walls, utility panels, building utilities, or any combination thereof. The structural frame members, panels or walls may provide support for the wall, ceiling and floor panels.

The examples provided herein are for explanatory purposes only and should not be considered to limit the scope of the disclosure. Each example embodiment may be practical for a particular environment such as urban mixed-use developments, low-rise residential units, and/or remote communities. Materials and dimensions for individual elements may be configured to comply with one or more of the following building codes: fire, energy, handicap, life-safety, and acoustical (impact and ambient noise transfer) without departing from the scope of the principles of the disclosure. The elements and/or system may also be configured to comply with social and/or religious codes as desired. For example, materials, systems, methods, and/or apparatuses may be configured to comply with the International Building Code as it has been adopted in a jurisdiction. Furthermore, various components have been referenced above as being field panel installed, field finish installed, and factory installed for some embodiments. Other embodiments may be provided in which the installation location and/or installation method may be different than those specifically referenced above. Still further, the various dimensions, gauges, and other specifications for various components described above are for example purposes—other embodiments may be implemented with components having different dimensions, gauges, specifications, etc.

The present disclosure is not to be limited in terms of the particular embodiments described in this application, which are intended as illustrations of various aspects. Many modifications and embodiments can be made without departing from its spirit and scope. Functionally equivalent methods and apparatuses within the scope of the disclosure, in addition to those enumerated herein, are possible from the foregoing descriptions. Such modifications and embodiments are intended to fall within the scope of the appended claims. The present disclosure is to be limited only by the terms of the appended claims, along with the full scope of equivalents to which such claims are entitled. This disclosure is not limited to particular methods, which can, of course, vary. The terminology used herein is for the purpose of describing particular embodiments only, and is not intended to be limiting.

With respect to the use of substantially any plural and/or singular terms herein, the terms can be translated from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

If a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). Virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, the disclosure is also thereby described in terms of any individual member or subgroup of members of the Markush group.

For any and all purposes, such as in terms of providing a written description, all ranges disclosed herein also encompass any and all possible subranges and combinations of subranges thereof Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. All language such as “up to,” “at least,” “greater than,” “less than,” and the like include the number recited and refer to ranges which can be subsequently broken down into subranges as discussed above. Finally, a range includes each individual member. Thus, for example, a group having 1-3 items refers to groups having 1, 2, or 3 items. Similarly, a group having 1-5 items refers to groups having 1, 2, 3, 4, or 5 items, and so forth.

The herein described subject matter sometimes illustrates different components contained within, or connected with, different other components. Such depicted architectures are merely embodiments, and in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific embodiments of operably couplable include but are not limited to physically mateable and/or physically interacting components.

While various aspects and embodiments have been disclosed herein, other aspects and embodiments are possible. The various aspects and embodiments disclosed herein are for purposes of illustration and are not intended to be limiting.

1. A floor panel, comprising:
a first cement board layer;
a hydronic foam layer disposed below the first cement board layer;
hydronic piping disposed within the hydronic foam layer;
a second cement board layer disposed below the hydronic foam layer;
one or more joists coupled to a bottom surface of the second cement board layer;
one or more gypsum board layers disposed below the one or more joists, wherein the one or more joists are coupled to a top surface of the one or more gypsum board layers; and
one or more layers of insulation disposed in a space defined by the second cement board layer, the one or more joists, and the one or more gypsum board layers.

2. The floor panel of claim 1, further comprising a first sheet metal member disposed between the second cement board layer and a top of the one or more joists, and a second sheet metal member disposed between a bottom of the one or more joists and a top surface of the one or more gypsum board layers.

3. The floor panel of claim 2, wherein the first cement board layer and the second cement board layer are attached to the first sheet metal member via one or more fasteners.

4. The floor panel of claim 1, wherein the one or more gypsum board layers comprises two fiberglass sheathed gypsum board layers.

5. A roof panel, comprising:
a roofing material layer;
a protection board layer disposed beneath the roofing material layer;
a rigid insulation layer disposed beneath the protection board layer;
a vapor retarder disposed beneath the rigid insulation layer;
a first cement board layer;
a hydronic foam layer disposed below the first cement board layer;
hydronic piping disposed within the hydronic foam layer;
a second cement board layer disposed below the hydronic foam layer;
one or more joists coupled to a bottom surface of the second cement board layer;
one or more gypsum board layers disposed below the one or more joists, wherein the one or more joists are coupled to a top surface of the one or more gypsum board layers; and
one or more layers of insulation disposed in a space defined by the second cement board layer, the one or more joists, and the one or more gypsum board layers.

6. The roof panel of claim 5, further comprising a first sheet metal member disposed between the second cement board layer and a top of the one or more joists, and a second sheet metal member disposed between a bottom of the one or more joists and a top surface of the one or more gypsum board layers.

7. The roof panel of claim 6, wherein the first cement board layer and the second cement board layer are attached to the first sheet metal member via one or more fasteners.

8. The roof panel of claim 5, wherein the one or more gypsum board layers comprises two fiberglass sheathed gypsum board layers.

9. A modular building system, comprising:
a demising wall, comprising:
an insulation section;
a first gypsum board layer installed on a first side of the insulation section;
a second gypsum board layer installed over on a second side of the insulation section, opposite the first side of the insulation section;
a first plurality of hat channels coupled to the first gypsum board layer;
a second plurality of hat channels coupled to the second gypsum board layer;
first finish panels coupled to the first plurality of hat channels via first trim pieces; and
second finish panels coupled to the second plurality of hat channels via second trim pieces.

10. The modular building system of claim 9, wherein the demising wall further comprises:
a first sheet metal member installed on an interior surface of the first gypsum board layer between the insulation section and the first gypsum board layer; and
a second sheet metal member disposed on an interior surface of the second gypsum board layer between the insulation section and the second gypsum board layer.

11. The modular building system of claim 9, wherein the first gypsum board layer of the demising wall includes fiberglass sheathed gypsum board, and wherein the second gypsum board layer of the demising wall includes fiberglass sheathed gypsum board.

12. The modular building system of claim 9, further comprising:
a utility wall, comprising:
an insulation section;
an insulation board installed on a first side of the insulation section;
a first gypsum board layer installed over the insulation board on the first side of the insulation section;
a second gypsum board layer installed on a second side of the insulation section, opposite the first side of the insulation section;
a weather resistive barrier installed over the first gypsum board layer; and
a vapor retardant layer installed over the second gypsum board layer.

13. The modular building system of claim 12, wherein the utility wall further comprises:
one or more furring members coupled to an exterior of the utility wall over the weather resistive barrier; and
one or more external finish panels coupled to the one or more furring members.

14. The modular building system of claim 13, wherein the utility wall further comprises:
one or more hat channel members coupled to the second gypsum board layer;
one or more trim pieces corresponding to the one or more hat channel members; and
one or more interior finish panels coupled to the utility wall via the trim pieces.

15. The modular building system of claim 12, wherein the insulation section of the utility wall includes a plurality of insulation layers.

16. The modular building system of claim 9, further comprising:
an end wall, comprising:
an insulation section;
a thermal insulation layer installed on a first side of the insulation section;
a first gypsum board layer installed on a side of the thermal insulation layer opposite the insulation section;
a weather resistant barrier installed on a side of the first gypsum board layer opposite the thermal insulation layer;
a second gypsum board layer installed on a second side of the thermal insulation layer opposite the first side of the thermal insulation layer; and
a vapor retardant layer installed on an interior surface of the second gypsum board layer between the second gypsum board layer and the insulation section.

17. The modular building system end wall of claim 16, wherein the end wall further comprises:
a first sheet metal layer installed on an interior surface of the thermal insulation layer between the thermal insulation layer and the insulation section; and
a second sheet metal layer installed on an interior surface of the second gypsum board layer between the second gypsum board layer and the insulation section.

18. The modular building system of claim 17, wherein the end wall further comprises:
one or more hat channel members coupled to the second gypsum board layer of the end wall;
one or more interior finish panels coupled to the hat channel members via corresponding trim pieces; and
insulation installed in a space defined by the second gypsum board layer of the end wall, the one or more hat channel members, and the interior finish panels.

19. The modular building system of claim 9, further comprising:
a corbel beam, comprising:
a hollow structural section beam; and
a wide flange beam disposed within the hollow structural section beam,
wherein the hollow structural section beam is filled with grout so as to surround the wide flange beam disposed within the hollow structural section beam.

20. The modular building system of claim 19, wherein the corbel beam further comprises a plate installed within the hollow structural section beam and adjacent a flange of the wide flange beam within the hollow structural section beam.
